(19) United States
(12) Patent Application Publication
(10) Pub. No.: US 2007/0183439 A1
(43) Pub. Date: Aug. 9, 2007

(54) Combined directional and mobile interleaved wireless mesh network

(76) Inventor: Robert Osann JR., Cupertino, CA (US)

Correspondence Address: FLIESLER MEYER LLP, 650 CALIFORNIA STREET, 14TH FLOOR, SAN FRANCISCO, CA, 94108, US

(21) Appl. No.: 11/592,805

(22) Filed: Nov. 3, 2006

Related U.S. Application Data
(60) Provisional application No. 60/756,794, filed on Jan. 5, 2006.

(51) Int. Cl. H04L 12/56

(52) U.S. Cl. 370/406

(57) ABSTRACT

A combined fixed directional and mobile omnidirectional interleaved wireless mesh network is described where the fixed mesh nodes have directional antennas facing in horizontally orthogonal directions. The antennas can be focused to have a horizontal beam width of less than ninety degrees in order to achieve greater strength of signal and radiation. Each directional node can have multiple radios that communicate on separate channels, such that packets propagated through the mesh network can utilize any channel to enter or leave a particular node. The combined network also includes mobile nodes that utilize multiple radios, each connected to an omnidirectional antenna and operating on a different channel. The mobile nodes can maintain constant communication with the directional nodes as they move between various quadrants covered by the directional nodes. The mobile nodes can also maintain connections to each other even during the loss of communication with the fixed directional nodes.

### CLAIM OF PRIORITY

This application claims the benefit and priority of U.S. Provisional Application Ser. No. 60/756,794, filed on Jan. 5, 2006, and entitled “DIRECTIONAL AND INTERLEAVED WIRELESS MESH NETWORKS,” commonly assigned with the present application and incorporated herein by reference.

### CROSS REFERENCES TO RELATED APPLICATIONS

This application is related to and cross references the following U.S. Patent Applications, which are incorporated herein by reference:

U.S. patent application Ser. No. 11/507,921 entitled “INTERLEAVED AND DIRECTIONAL WIRELESS MESH NETWORK,” by Robert Osann, Jr., filed on Aug. 22, 2006, Attorney Docket No. OSAN-01003US0.

U.S. patent application Ser. No. 11/503,036 entitled “INTERLEAVED WIRELESS MESH NETWORK,” by Robert Osann, Jr., filed on Aug. 11, 2006, Attorney Docket No. OSAN-01004US0.

U.S. patent application Ser. No. 11/516,995 entitled “SYNCHRONIZED WIRELESS MESH NETWORK,” by Robert Osann, Jr., filed on Sep. 7, 2006, Attorney Docket No. OSAN-01005US0.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates generally to the field of wireless mesh networks for public safety and general public access applications.

### BACKGROUND OF THE INVENTION

Typical wireless mesh networks use a single radio for the backhaul or relay function where packets are moved through the mesh from node to node. This causes a significant bandwidth limitation since a single radio cannot send and receive at the same time. Adding relay radios at individual mesh nodes can enable a mesh node to simultaneously send and receive packets, thereby increasing the overall rate of bandwidth propagation through the mesh node. The simplest form of prior art mesh network is the ad hoc mesh network shown in FIG. 1(a), where each mesh node 101 contains a relay radio 102. This is the most elemental form of wireless mesh network and originated in the military. It was characteristic of these networks that all mesh nodes have a single radio and all radios operate on the same channel or frequency.

Note that in this specification, the term “channel” is most often used to mean a specific RF frequency or band of frequencies. However, the term “channel” is to be understood in a generalized sense as designating a method of isolating one data transmission from others such that they do not interfere. While this differentiation or isolation may be accomplished by utilizing different frequencies, it may also be accomplished by choosing different RF wave polarizations or in the case of a TDMA scheme, it may refer to different time slots in a time division scheme. For CDMA systems, isolation of transmissions may result from having different spreading codes. Regardless, channelization is a method for making efficient use of available spectrum and preventing interference between different transmissions that otherwise might interfere with each other.

One evolution of the early ad hoc mesh network form is shown in FIG. 1(b) where relay radio 103 is capable not only of transferring packets to adjacent nodes, but is also capable of operating as an access point (AP) as well, providing service (typically WiFi) to client devices such as laptop computers, wireless PDAs, and WiFi VoIP phones.

The architecture of FIG. 1(b) suffers from performance limitations since the single radio must not only relay packets, but also service numerous client radios 104 at each node. Thus, another evolution was developed as shown in FIG. 1(c), where each mesh node has a separate service or AP radio 105 in addition to relay radio 106. This allows client devices 107 to communicate with service radio 105 on a different channel or frequency than relay radio 106, thereby reducing interference effects within the mesh and increasing performance.

A more recent evolution of mesh architectures is shown in FIG. 1(d) where relay radios 108 and 109 are used at each mesh node along with a separate service radio 110. Here, packets can be received on relay radio 108 while simultaneously being transmitted on relay radio 109, and vice versa, thereby increasing performance due to both the simultaneous operation of both radios, as well as the fact that radios 108 and 109 typically operate on different channels, thereby further reducing interference effects in the mesh. It is also known to add radios to the architecture shown in FIG. 1(d) such that there would be two relay radios for uplink replacing relay radio 108, and two relay radios for downlink replacing relay radio 109. This addition effectively doubles the bandwidth and enables full-duplex (simultaneous uplink and downlink) operation, however a specific packet stream will propagate through only one of a pair of uplink or downlink radios. Thus, the maximum performance of such a link between two nodes will only be realized in situations where traffic loading is high. The absolute performance of a single stream of packets will not be increased beyond what a single link could deliver.

While FIG. 1 shows the architectures for various prior art mesh networks in a one-dimensional form for sake of simplicity, FIG. 2 elaborates on the architecture of FIG. 1(d) showing a two-dimensional view. In the 3-radio mesh of FIG. 2, also known as a “structured” mesh, a tree-like structure is formed emanating from a root node 201 which connects directly to a wired network 202. This wired network can, in turn, connect to the Internet or alternatively, it may connect simply to a server. In the case of a public safety network, the wired network will often connect to the Command and Control center. It is characteristic of this type of mesh that, at every hop, packets being relayed travel on a different channel from the previous hop. Thus RF transmissions, 202, 203, and 204 which connect mesh node 201(a with mesh nodes 205, 206, and 207, operate on three different channels or frequencies as shown by the different styles of dotted line. In this type of mesh network, the mesh control software on each node has a significant challenge in assigning the various available channels throughout the mesh such that interference effects are minimized, and the mesh functions properly. Some mesh network vendors rely on customers to manually assign channels as the units are being installed. Other mesh vendors have developed very elaborate dynamic channel assignment software programs, which perform this function automatically. Either way, having a mesh network where channels change from hop to hop is complicated and difficult to deal with. In the case of a public safety mesh with mobile nodes (for vehicles and individual First Responders on foot), a further problem arises with this form of mesh. For instance, if a group of first responders each carrying a mesh node becomes isolated from the backhaul connection to the server (Command and Control), the tree-like structure of FIG. 2 may become compromised since there is no longer a defined root for the tree. It is important for isolated groups of first responders, with nodes that are vehicle mounted, man-carried, or both, to continue communicating amongst themselves when isolated until the connection to Command and Control is restored.

FIG. 3 shows example channel configurations in a WLAN Mesh from section 4.2.3 of IEEE 802.11-06/0328r0, the Combined Proposal for the ESS Mesh Standard (published in March 2006). It should be noted that the publication referenced here post dates the filing of U.S. Provisional Application Ser. No. 60/756,794 to which the present application claims priority. However, in the event that this information had been published in previous submittals at prior IEEE standards meetings, and also for purposes of clarity, the information in this publication is being described herein. FIG. 3(a) shows a simple ad hoc mesh, while FIG. 3(b) shows two ad hoc meshes, 301 and 302, which are bridged by central mesh node 303 having two radios. FIG. 3(c) shows a number of mesh nodes, each having two radios for packet relay, which for the most part are being utilized in a manner similar to the “structured” mesh of FIG. 2. FIG. 3(c) also demonstrates the concept of nodes with 2-radio relays being used to bridge between one sub-mesh and another. This referenced proposal for a new mesh standard also discusses the concept of Unified Channel Graphs or UCGs. In FIGS. 3(d) and 3(e), notice that FIGS. 3(b) and 3(c) are replicated with superimposed circles 304 indicating nodes which communicate with each other on a particular channel. Essentially FIG. 3(e) demonstrates a number of sub-meshes which are bridged by mesh nodes, each bridging node containing two relay radios. One can easily imagine the challenge in assigning channels to the network demonstrated in FIGS. 3(c) and 3(e). Also, when connections between nodes must change because of a node failure, temporary disturbances to the mesh (moving obstacles or radar interference), node movement, or QOS considerations, there can be a ripple effect of changing channels causing even greater complexity.

FIG. 4 shows the architecture for the only mesh network solution that currently supports both public safety and public access, and is being sold by Motorola. Here, there are two completely separate mesh systems embodied in the same enclosure 401. Each enclosure has two radios 402 for public safety and two radios 403 for public access. Each of these separate meshes functions as a “1+1” mesh as demonstrated in FIG. 1(c) by radio elements 105 and 106. This vendor has chosen to make the public access radios utilize 2.4 GHz for both relay and service, with 4.9 GHz being utilized for the public service radios (relay and service). Each of these meshes is separate from the other with no interaction. In particular, packet traffic on the 4.9 GHz mesh may only be used for public service as governed by law—public access traffic may never utilized 4.9 GHz. Thus, this prior art solution addresses the problem that it is desirable to reduce the number of mesh unit enclosures that must be mounted at strategic locations to cover a metropolitan area. However, the solution does not integrate any additional functionality beyond what is shown in FIG. 4, and from a performance standpoint, each of the two individual mesh networks embodied here will have the performance restrictions of other prior art mesh architectures constructed according to FIG. 1(c).

It would therefore be desirable to have a wireless mesh network architecture with the performance characteristics provided by a 2-radio relay, without the complexity of managing multiple and dynamically changeable channels, which can change from hop-to-hop.

The majority of mesh nodes being installed today use omnidirectional antennas for the relay or backhaul function to transfer packets between mesh nodes. While some mesh vendors claim to have installed mesh networks in hundreds of cities, all but a few of these are suburban towns, not large cities with tall buildings. In fact, none of the mesh systems offered today have been designed to handle the problems encountered in the depths of larger cities where high rise buildings create a “concrete canyon” effect. When today's mesh nodes are deployed in such situations, much of the energy radiated from their omni-directional antennas is reflected and/or wasted. As will be shown in FIGS. 11 and 12, in such circumstances most of the energy radiated from a relay radio's omnidirectional antenna is directed at buildings, rather than down the street corridor to where other mesh nodes are located. Here, directional or sector antennas can offer significant advantages. Throughout this specification, directional and sector antennas are often used interchangeably. This is because they sometimes are interchangeable when one desires to focus the transmitted RF radiation, depending on just how narrow a beam is desired. In one sense, any antenna that is not “omnidirectional” can be considered “directional”. However, among RF engineers, there is often a distinction between sector and directional antennas, as they differ to some extent. A sectoral or sector antenna has a horizontal beam angle that is measured in substantial portions of 180 degrees, most frequently, 90 degrees. They are often available with horizontal beam angles as small as 30 degrees, and one can think of them as covering a piece of the “360 degree pie”, hence the term “sector”. To focus the RF energy even more, a variety of types of “directional” antennas are available, usually with significantly higher gains. Directional antennas come in a variety of configurations referred to as “dish”, “panel”, “patch”, or “reflector grid”, to name a few. A 32 dBi dish antenna, for instance, would have both horizontal and vertical beam widths of 5 degrees, not something one would think of as covering a “piece of a pie” as with sector antennas.

Other factors involved in mesh node and mesh architecture design involve both the transmit power and cost of radio cards. The cost of radio cards for wireless networks is becoming increasingly lower, and although many of these have relatively low power, when combined with directional or sector antennas the EIRP (total transmitted power output from the antenna) can be more than acceptable, especially if utilized in a city deployment where the transmit energy can be focused in order to propagate between buildings, rather than wasted by transmitting into buildings.

### SUMMARY

An interleaved mesh is described that uses at least two relay radios on each node to create two or more simultaneous mesh networks, each on separate channels. A transmitted stream of packets will then utilize any or all of these multiple simultaneous meshes as they propagate through the overall mesh network. For any particular hop, a packet may use any of the available meshes to propagate to the next node. From hop to hop, a particular packet may change which mesh it travels on to reach the next node. Here, two sequential packets in a particular packet stream may travel on the same mesh or on different meshes for any given hop. Two sequential packets can even be transmitted simultaneously from a first node to a second node. Thus, a single stream of sequential packets may be transmitted between two mesh nodes at twice the speed that would normally occur if only a single link were used, or even if multiple links were used but limited to propagating unique streams of packets separately on each link. Therefore, the performance of the highest priority packet stream will be improved regardless of whether traffic loading in the mesh is high or low at the time of transmission.

When two radios are used on a particular node for packet relay according to an interleaved mesh per this invention, data can be received on one radio while simultaneously being sent on the other radio. This circumvents the limitations of a single radio system without requiring complex channel management schemes, while at the same time providing a mesh that can easily operate without a server or internet connection—critically important for Public Safety applications when isolated First Responders are separated from their backhaul connection and must communicate among themselves.

To take advantage of the low cost of commonly available radio cards while compensating for their relatively low power and receive sensitivity, a mesh architecture is also described where a relatively large number of radios is used with multiple directional or sector antennas, or multi-element directional antennas, such that radiated energy is effectively focused. This is particularly useful in urban applications where the relay or backhaul path between nodes must travel between tall buildings, a narrow beam directional or sector antenna being most efficient for the task. This directional mesh architecture is designed as shown such that it is compatible with the interleaved mesh described earlier, thus facilitating a Public Safety mesh that supports both fixed nodes (with directional or sector antennas) and mobile nodes (with omni antennas) where the mobile nodes can be man-carried or mounted on vehicles.

Frequencies utilized include licensed bands for Public Safety applications and unlicensed bands for Public Service (Public Access) applications. Architectures are also shown that support both Public Safety applications and Public Service applications simultaneously.

In summary, one object of this invention is to increase performance when packets are relayed through the mesh by providing multiple radios on each node for the relay function. Here, two sequential packets in a particular packet stream may travel on the same mesh or on different meshes for any given hop.

Another object of this invention is to provide multiple radios on each mesh node without requiring a dynamic channel assignment scheme, and thereby utilizing simpler and more mature mesh management software.

Another object of this invention is to provide a more robust mesh architecture where redundant meshes are used between nodes, thereby maintaining an automatic backup path should any disturbance happen to one of the multiple mesh packet propagation paths.

Another object of this invention is to provide an alternative path for packets on a different channel should radar interference occur on one channel causing one of the multiple interleaved meshes to need to change channels, otherwise known as DFS or Dynamic Frequency Selection. Here, when radar interference occurs on a channel of a first mesh of the multiple meshes of an interleaved mesh network, traffic can continue to propagate on a second mesh while the first mesh changes to a different channel. This eliminates the gap in performance that occurs when a DFS change is executed on prior art meshes. Thus all nodes in the system are aware of the number of meshes available and the channels they each utilize.

Another object of this invention is to support mobile public safety mesh, while providing an increased level of performance over traditional mobile mesh with single radio relay.

Another object of this invention is to provide an architecture where multiple radios can be utilized at lower frequencies with higher penetration capabilities for certain public safety applications. Frequencies in the 700 MHz to 900 MHz range have great penetration and range capabilities, but are prone to adjacent channel interference. By using two interleaved meshes on greatly separated frequencies, these problems can be overcome and provide a 2-radio relay capability.

Another object to this invention is to support directional or sector antennas on fixed mesh nodes in an architecture which integrates seamlessly with mobile mesh nodes, and supports a multi radio relay on both fixed and mobile mesh nodes.

Another object of this invention is to support mobile mesh nodes with multiple radio relay capability that are able to operate independently as an isolated group, when such groups are isolated from a primary server or command and control connection.

Another object of this invention is to support fixed mesh nodes with multiple directional or sector antennas, where some radios on the same node connect to antennas facing in different directions and operating on the same channel, thus enabling communication with mobile nodes which simultaneously support multiple meshes on multiple radios. Also, utilizing radios and antennas operating on the same channel but facing in different directions on the same mesh node reduces the total number of channels required for the mesh. Reducing the total number of channels required for the mesh can also provide more available spectrum for technologies such as channel bonding which can further increase performance.

Another object of this invention is to support fixed mesh nodes with multiple directional or sector antennas, where some radios on the same node connect to antennas facing in different directions and operating on the same channel, and these radios operate independently but are controlled such that the actions of transmitting and receiving are coordinated to eliminate the possibility that one radio is attempting to receive while another radio on the same mesh node and same channel is transmitting, thereby eliminating the local co-channel interference which would otherwise result at that node.

Another object of this invention is to provide a mesh infrastructure with multiple radios that provides higher performance overall for video broadcast distribution and video multicast for video surveillance.

Another object of this invention is to provide multiple radios connected to multiple sector antenna structures, where individual sector antennas are “ganged” together as constructed to form a single antenna assembly.

Another object of this invention is to provide multiple groups of sector antennas where each group is “ganged” together, each gang of sector antennas being individually adjustable in both azimuth and elevation.

Another object of this invention is to provide an interleaved mesh architecture where WiMax radios could be utilized for the relay function as well as the service radio function for client access.

Another object of this invention is to provide an interleaved mesh architecture where MIMO radios and antennas could be utilized.

### BRIEF DESCRIPTION OF THE DRAWINGS

The present invention is described with respect to particular exemplary embodiments thereof and reference is accordingly made to the drawings in which:

FIG. 1 shows a 1-dimensional view for a variety of prior art mesh network architectures, including both 1-radio relay and 2-radio relay.

FIG. 2 shows a prior art “structured” mesh architecture with 2-radio relay in a 2-dimensional view.

FIG. 3 shows example topologies and channel configurations in a WLAN Mesh from section 4.2.3 of IEEE 802.11-06/0328r0, the recently published Combined Proposal for the ESS Mesh Standard (March 2006).

FIG. 4 shows a prior art mesh network which supports both public safety and public access by combining two separate mesh networks in one enclosure, each mesh network supported with one relay radio and a separate AP radio.

FIG. 5 shows one example of an interleaved wireless mesh network per the present invention, where each mesh node has at least two radios supporting at least two parallel mesh networks that are used in conjunction to propagate a single packet stream.

FIG. 6 shows the interleaved mesh network of the present invention, demonstrating how a single packet stream propagates by using both meshes, traveling on one or the other mesh for any given hop.

FIG. 7 shows the interleaved mesh network of FIG. 6 where a service or AP radio has been added, so that the mesh can communicate with client devices such as laptop computers independent of communications which happen on the relay radios.

FIG. 8 shows some examples of how packets can propagate through an interleaved mesh, ignoring interference affects.

FIG. 9 shows how bandwidth degrades over a one radio relay as a result of adjacent node interference effects.

FIG. 10 shows some examples of how packets can propagate through an interleaved mesh once interference affects are taken into account.

FIG. 11 shows a problem that results when omnidirectional antennas are used in a city with tall buildings.

FIG. 12 shows a solution to the problem of FIG. 11 where multiple sector antennas are used to focus energy between tall buildings in a city.

FIG. 13 shows a problem that results when omnidirectional antennas are used over irregular terrain.

FIG. 14 shows a solution to the problem of FIG. 13 where sector antennas may be aimed in order to compensate for irregular terrain.

FIG. 15 shows an interleaved directional mesh where multiple sector antennas are used in different directions, and also shows the energy radiation pattern for a 90° sector antenna.

FIG. 16 shows an interleaved directional mesh where multiple sector antennas are used in different directions, and a single radio with a four-way (4:1) splitter is used to simultaneously drive four antennas which face in four substantially orthogonal directions.

FIG. 17 shows an interleaved directional mesh where multiple sector antennas are used in different directions, and a single radio with a four-way (4:1) splitter is used to simultaneously drive four antennas which face in four substantially orthogonal directions, an independent RF switch being placed between each output of the four-way splitter and each of the four orthogonally directed sector antennas.

FIG. 18 shows a fixed directional interleaved mesh node according to this invention making an RF connection to mobile interleaved mesh nodes, also according to this invention.

FIG. 19 shows how packets might propagate through the fixed directional mesh node and mobile nodes of FIG. 18, taking an interleaved path where packets sometimes travel on the A-channel mesh and sometimes travel on the B-channel mesh.

FIG. 20 shows a fixed directional mesh node and two mobile mesh nodes both supporting interleaved mesh, the fixed mesh node having separate interleaved meshes—one for public safety and one for public access, with each interleaved mesh having separate service radios.

FIG. 21 shows fixed and mobile interleaved mesh nodes similar to those of FIG. 23 except that separate service radios are supported only for public access.

FIG. 22 shows a multi-function mesh node that supports both Public Safety and Public Access functions with a separate interleaved mesh for each. This fixed mesh node implements the directional mesh paradigm described herein with a “ganged antenna” approach, and also communicates with mobile nodes having omnidirectional antennas that also utilize the interleaved mesh paradigm. Also incorporated with the mesh node of FIG. 22, either integral with or attached thereto are various sensors for video surveillance and airborne hazardous materials as well as seismic and wind sensors, thereby enabling a grid of such mesh nodes to effectively form a comprehensive sensor network covering a metropolitan area.

FIG. 23 shows a detailed picture of the ganged sectoral antenna array that can be used in the implementation of the directional mesh node of FIG. 22.

FIG. 24 shows a fixed and mobile interleaved mesh supporting public safety applications, where public access is supported by a mesh with single radio relay only plus a separate service radio.

FIG. 25 shows a fixed and mobile interleaved mesh supporting public safety applications specifically, where a separate service radio is not required.

FIG. 26 shows a grid of fixed mesh nodes where channels have been pre-assigned to reduce co-channel interference on each mesh node and still interface with mobile mesh nodes.

FIG. 27 shows a sequence where the mobile mesh nodes of FIG. 26 move from one quadrant of a fixed mesh node to another quadrant and maintain connectivity with the fixed node due to the manner in which channels were assigned on the fixed mesh node.

FIG. 28 shows a grid of mesh nodes where channels have been pre-assigned to eliminate co-channel interference on each mesh node, each individual radio on a fixed mesh node having a different channel from all other individual radios on that same node.

FIG. 29 shows the first part of a sequence where the mobile mesh nodes of FIG. 28 move from one quadrant of a fixed mesh node to another quadrant, and maintain connectivity due to the way in which connections disengage and re-engage on some radios versus others of the fixed mesh node.

FIG. 30 shows the second part of a sequence where the mobile mesh nodes of FIG. 28 move from one quadrant of a fixed mesh node to another quadrant, and maintain connectivity due to the way in which connections disengage and re-engage on some radios versus others of the fixed mesh node.

FIG. 31 shows a fixed directional mesh node and two mobile mesh nodes both supporting interleaved mesh, the fixed mesh node having separate interleaved meshes—in this case both used for public safety. It includes a first interleaved mesh similar to the fixed directional interleaved mesh shown in FIG. 28 having independent radio antenna combinations and used for packet relay operations, this first interleaved mesh combined with a second interleaved mesh similar to those of FIGS. 16 and 17 where a single radio drives four orthogonal antennas, this second interleaved mesh on the same fixed node being used to couple with mobile interleaved mesh nodes.

### DETAILED DESCRIPTION

The invention is illustrated by way of example and not by way of limitation in the figures of the accompanying drawings in which like references indicate similar elements. References to embodiments in this disclosure are not necessarily to the same embodiment, and such references mean at least one. While specific implementations are discussed, it is understood that this is done for illustrative purposes only. A person skilled in the relevant art will recognize that other components and configurations may be used without departing from the scope and spirit of the invention.

In the following description, numerous specific details are set forth to provide a thorough description of the invention. However, it will be apparent to those skilled in the art that the invention may be practiced without these specific details. In other instances, well-known features have not been described in detail so as not to obscure the invention.

One of the key components of the present invention is the new functionality herein called interleaved wireless mesh. In an interleaved mesh, at least two physical wireless mesh networks are utilized in parallel to propagate single streams of packets. In other words, a packet being transmitted from a mesh node will always have a choice of two or more meshes on which to propagate to the next mesh node, thus increasing the number of radios which can be simultaneously utilized to propagate a single packet stream. Note that a “packet stream” refers to a specific sequential stream of IP packets. Here, two sequential packets in a particular packet stream may travel on the same mesh or on different meshes for any given hop. Two sequential packets can even be transmitted simultaneously from a first node to a second node. Thus, a single stream of sequential packets may be transmitted between two mesh nodes at twice the speed that would normally occur if only a single link were used, or even if multiple links were used but limited to propagating unique streams of packets separately on each link. Therefore, the performance of the highest priority packet stream will be improved regardless of whether traffic loading in the mesh is high or low at the time of transmission.

Unlike prior art mesh networks with multi-radio relay architectures, the interleaved mesh does not require a complicated channel assignment scheme since typically each of the two meshes connecting to a given mesh node will always be on the same channels from hop to hop. Stated differently, an interleaved mesh can utilize multiple, parallel physical meshes to act like a single logical mesh network.

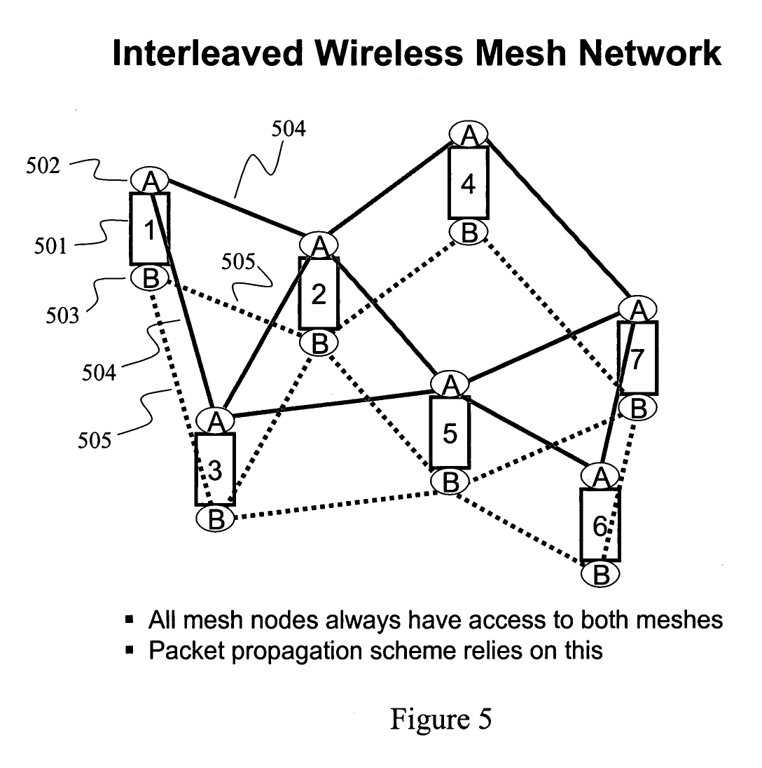

The basic architecture for interleaved mesh is most easily shown for an implementation where omnidirectional antennas are used and each mesh node has only two relay radios. This is demonstrated in FIG. 5 where mesh node 501 has two radios, radio 502 operating on a mesh which uses channel A and radio 503 operating on a mesh which uses channel B. Thus, radio 502 will make RF connections 504 on channel A to nodes 2 and 3, and radio 503 will make RF connections 505 on channel B to nodes 2 and 3. In this embodiment, all mesh nodes always have access to both mesh networks. As will be shown, the packet propagation scheme for an interleaved mesh relies on this fact, and both meshes are utilized to propagate a single packet stream. Since each relay radio in FIG. 5 is typically capable of connecting to all adjacent interleaved mesh nodes as shown, the concept of adjacency is important. For example, in FIG. 5, nodes 1,3,4, and 5 would all be considered as adjacent to node 2. Adjacent nodes are those with both physical position and connected RF signal strength so as to make a proper RF connection between them.

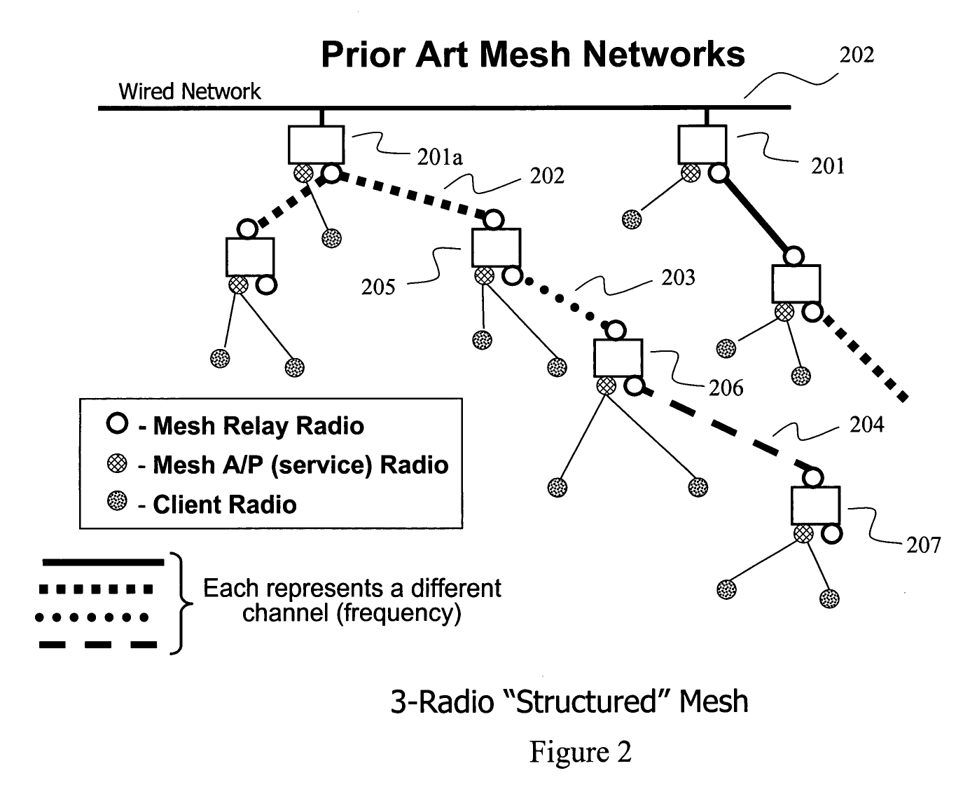

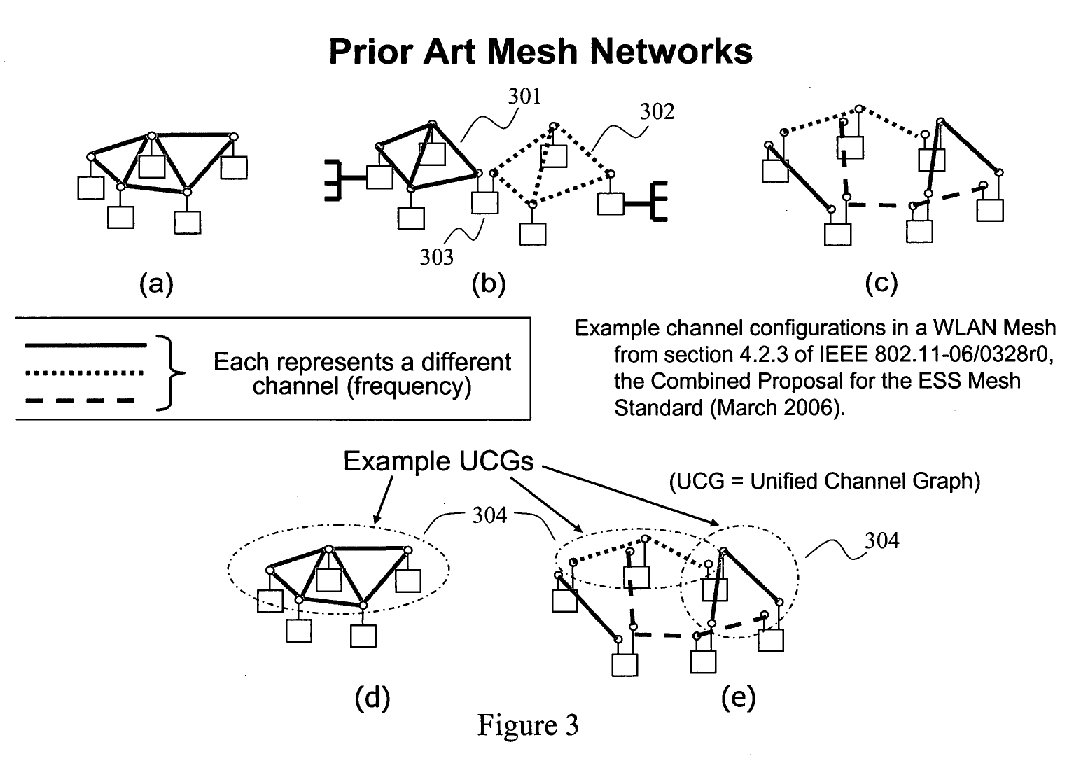

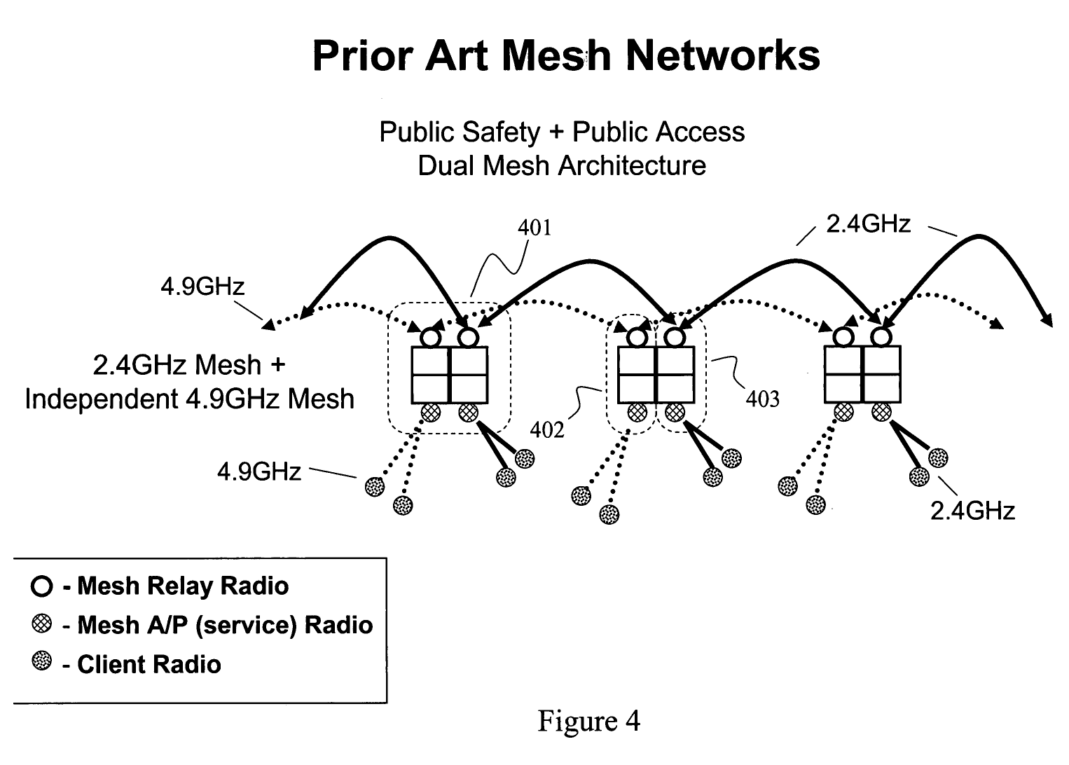

One benefit of having multiple, parallel meshes to propagate packets occurs when DFS (Dynamic Frequency Selection) is required to compensate for radar interference in certain frequency bands. Such a capability is required in a number of countries especially for the 5 GHz band. The European ETSI spec includes a required DFS capability. DFS provides an alternative path for packets on a second channel should radar interference occur on a first channel. The DFS specification as embodied in ETSI EN 301 893 v1.3.1 (August 2005) for the most part assumes a point to multipoint architecture where a single master device (at the hub) acts to control the slave devices relative to frequency channel utilization. However, the specification also states that devices capable of communicating in an ad-hoc manner shall also deploy DFS and should be tested against the requirements applicable to a master device according to the specification. For a conventional prior art mesh network, this means that if one mesh node detects interference on a particular frequency channel, it must notify all other mesh nodes that utilize that channel to change all communications currently operating on that channel to a different channel. For mesh networks with a single radio, single channel relay, this means that there will be an interruption in service during the “channel move time” which according to this specification can be as long as 10 seconds. An interruption of the just a few seconds can destroy a VoIP conversation and cause data losses where data streams back up and overflow data buffers. Even architectures such as that shown in FIG. 2 which include dynamic channel assignment, will have some data interruption while a number of links throughout the mesh are changed to alternate channels.

The interleaved mesh according to this invention handles DFS scenarios while maintaining a level of performance at least 50% as great as the maximum capability. When one of the multiple interleaved meshes according to this invention needs to change channels due to radar or other interference sources, the other mesh (or the others meshes if more than two parallel meshes are used) within the interleaved mesh architecture will continue to carry information during the “channel move time ”. Here, when radar interference occurs on the channel of a first mesh of the multiple meshes of an interleaved mesh network, a second mesh can be used to propagate the command which causes other nodes to change channels as well as propagate normal traffic while the first mesh changes to a different channel. This eliminates the gap in performance that occurs when a DFS change is executed on prior art meshes. In order to implement DFS as just described, it is important that all nodes in the system are aware of the number of meshes available and the channels they each utilize.

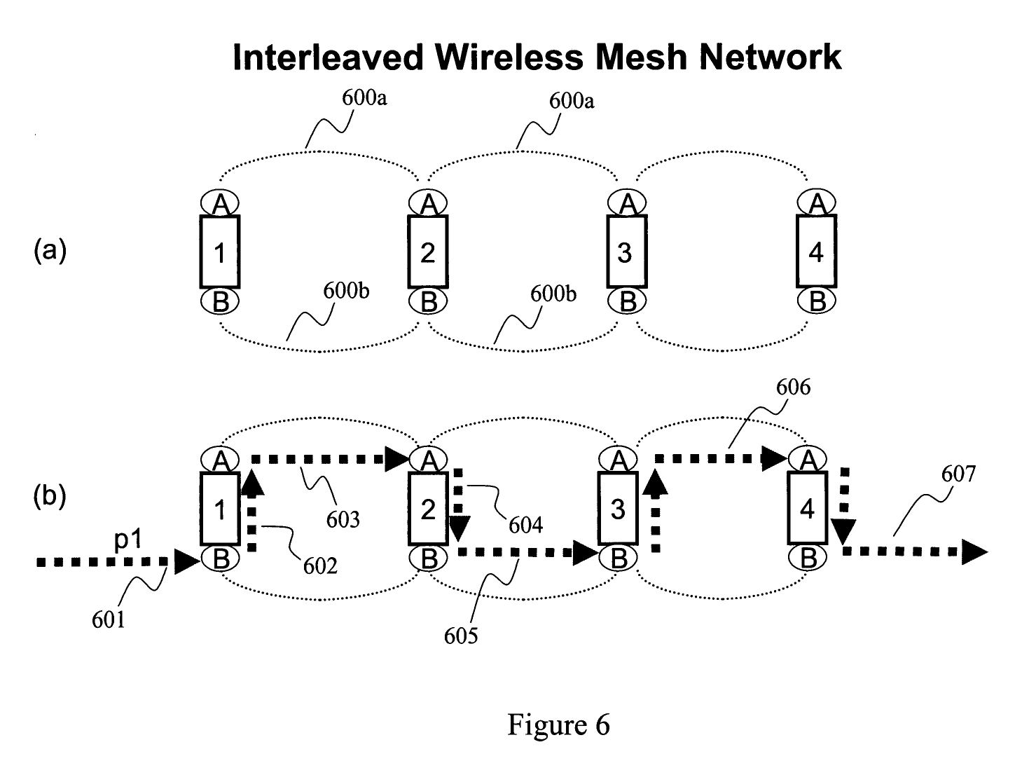

FIG. 6 shows a 1-dimensional architectural generalization for an interleaved wireless mesh according to this invention including a description for one scenario of packet propagation on an interleaved mesh. FIG. 6(a) shows four nodes, each supporting a wireless mesh 600(a) on channel A and another wireless mesh 600(b) on channel B. Omnidirectional antennas are assumed here. This four node mesh is shown here in basically a 1-dimensional “string of pearls” topology for sake of simplicity and clarity. It will be understood by those skilled in the art that all mesh networks described in this application can operate in a 2-dimensional mesh topology.

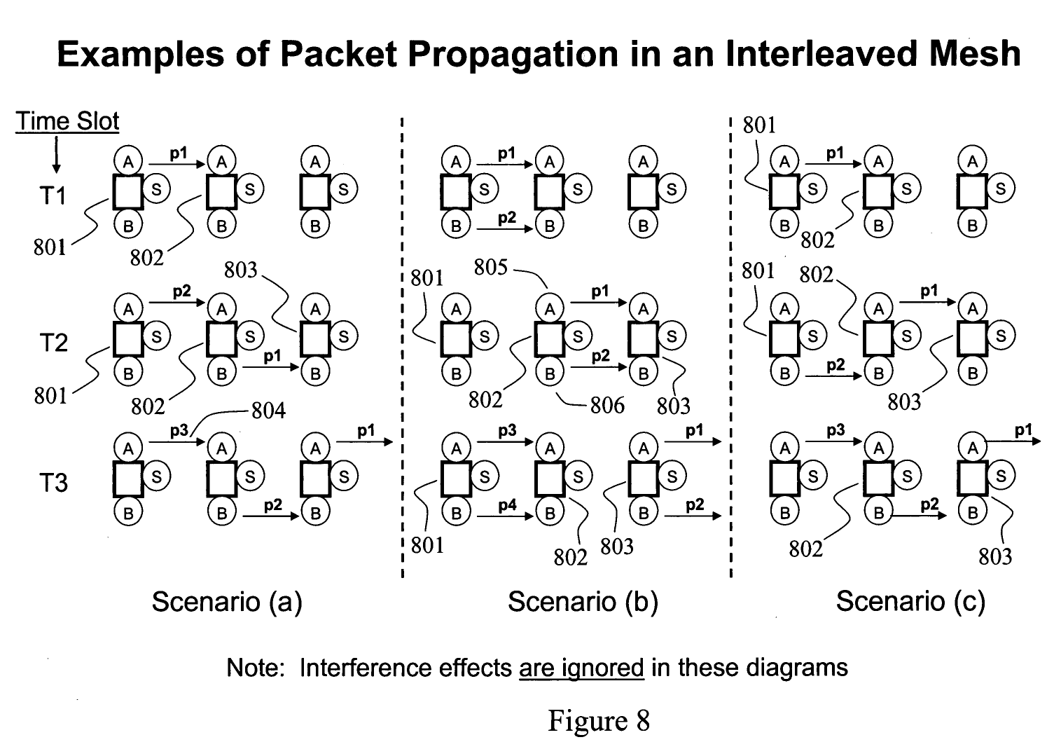

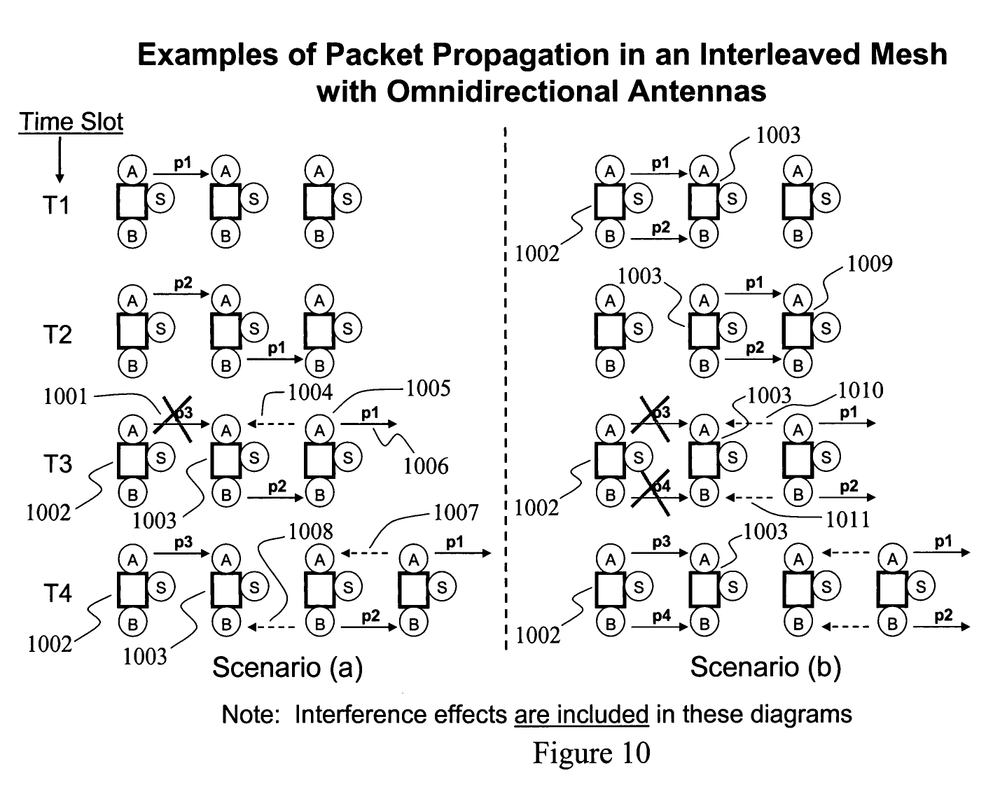

A possible packet propagation scheme for this interleaved mesh scenario is shown in FIG. 6(b) where a single packet p1 starts by entering 601 node 1 on the B-channel mesh. This same packet is then transferred 602 to the A-channel mesh from where it propagates 603 on the A-channel to node 2. The subject packet is then transferred 604 within node 2 back to the B-channel mesh, from where it propagates 605 to node 3. Thus, a single packet may bounce back and forth between one mesh and another mesh in a “ping-pong” or “interleaved” fashion as it propagates through the overall mesh network. At each of the four nodes shown, data can be received through either radio and if the other radio is currently free to transmit, then both radios on a node can be kept busy at the same time if interference effects allow (this will be discussed later). Other variations on packet propagation are possible and will be shown in more detail in FIGS. 8 and 10. Note that while later figures in this application will refer to nodes with omnidirectional antennas (such as those shown in FIG. 6) as mobile nodes, it should be apparent to those skilled in the art that such node configurations can be used in either fixed or mobile applications.

As a point of terminology, when a packet is transferred by RF transmission from one node to another, that transfer is referred to as a “hop”. Thus, in FIG. 6, transmissions 601, 603, 605, 606, and 607 all constitute hops, and per the definition of an interleaved mesh per this invention, a single packet may travel on any of multiple physical meshes (in this case the A-channel mesh or the B-channel mesh) for any given hop, as it travels through the overall mesh network.

In a multi-hop wireless mesh network, routing paths are typically planned in a distributed manner, each node determining where it must send a packet in order to move that packet towards an eventual destination. Thus, each node makes a decision for each packet that assigns that packet to a particular routing path. It is therefore very useful if each node has knowledge of other nodes in the network and any constraints that may exist at other points in the network. In other words, if there is a particular node in the network which is currently experiencing bandwidth limitations or an unusual amount of congestion, it is important for other nodes in the system to know this in order to direct packets in a direction that may bypass the impediment. At the same time, if connections between nodes exist in some other area of the mesh where bandwidth is especially high or congestion especially low, this information can also be useful in directing packets along the most optimum routing path. Again it is useful for a particular node to have knowledge of other nodes and connections within the mesh. Therefore in the interleaved mesh network according to the present invention, it is useful for each node to understand which other nodes in the network also have interleaved multi-radio relay capability, in order to plan the most optimum routing path.

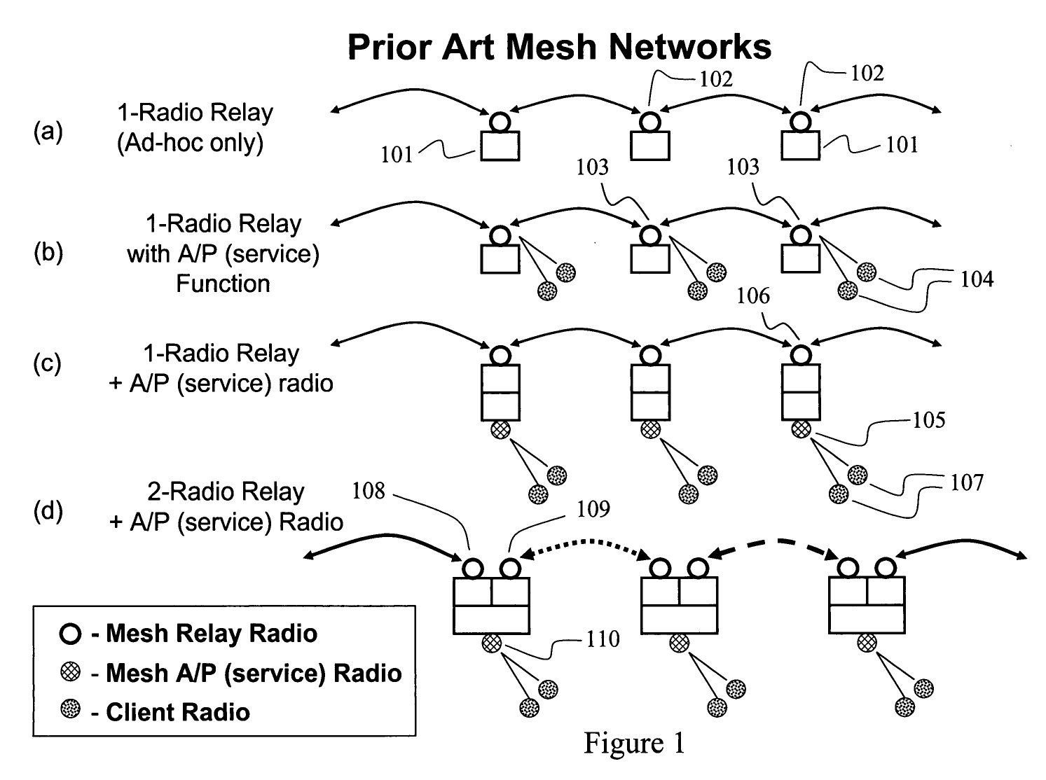

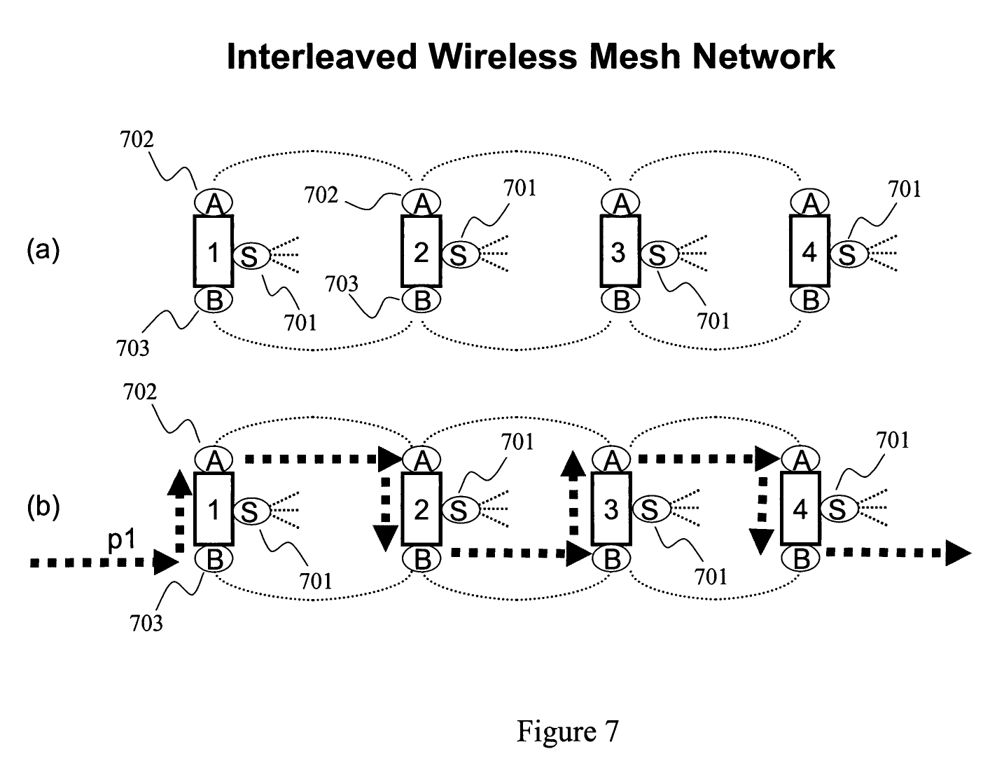

FIG. 7 is essentially identical to FIG. 6 but adds the functionality of a service or AP (access point) radio 701 which has been added to each mesh node. As embodied in a variety of prior art mesh architectures including FIGS. 1(c) and (d), having a separate service radio enables the relay radios 702 and 703 to operate on different channels (frequencies) than the service radio. Also, having a separate service radio provides for simultaneous operation of relay and service radios thus increasing overall performance.

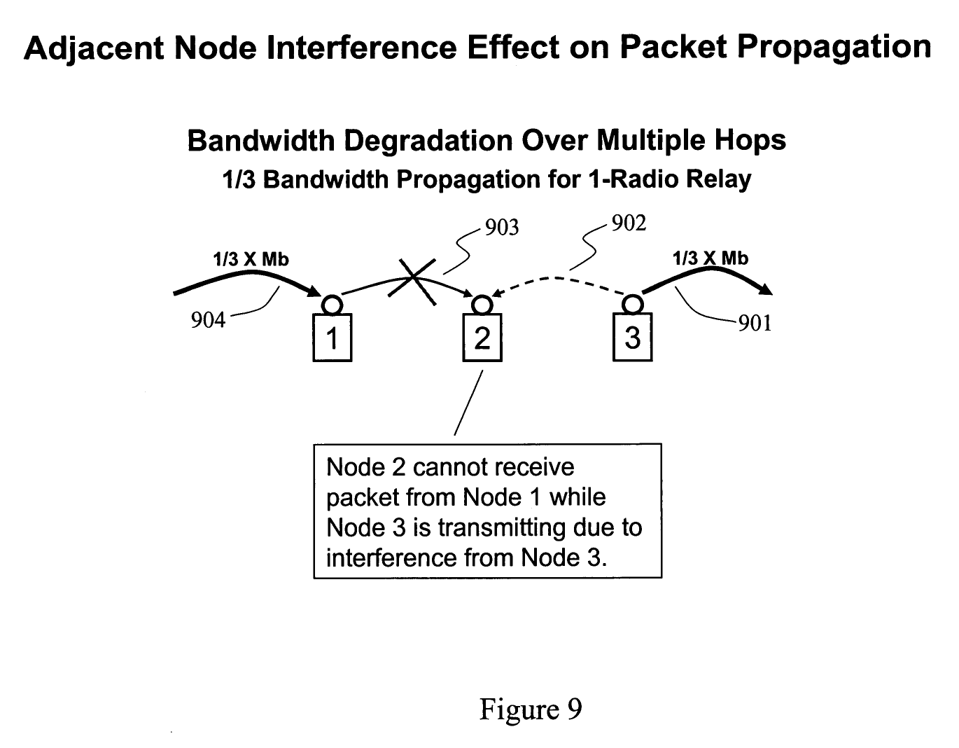

FIG. 8 shows examples of packet propagation scenarios through an interleaved or ping-pong mesh. Three scenarios are shown, (a), (b), and (c) for the propagation of sequential packets p1 through p4. For each scenario, packet propagation is shown for three sequential time slots, T1, T2, and T3. For the description of FIG. 8, adjacent node interference effects are temporary ignored to allow a simpler initial explanation of packet propagation. These effects will be explained in FIG. 9 and then incorporated into the packet propagation description in FIG. 10.

Timeslot T1 of scenario (a) in FIG. 8 shows packet p1 leaving node 801 and traveling to node 802 by way of the channel A mesh. Continuing scenario (a), timeslot T2 shows packet p1 progressing from node 802 to node 803, but this time propagating by way of the B-channel mesh. Concurrent with the propagation of packet p1 just described, packet p2 propagates from node 801 to node 802 on the A-channel mesh, thus demonstrating the ability of interleaved mesh nodes to simultaneously transmit and receive. Continuing scenario (a) further, timeslot T3 shows packet p1 and p2 progressing further, having “ping-ponged” to the opposite mesh, while packet p3 now enters the propagation stream 804 following p1 and p2 in sequence. Thus, it is also demonstrated that while packets in an interleaved or ping-pong mesh may travel on either of the multiple meshes for any given hop, the sequence of the packet stream is maintained such that the overall functionality is essentially the same as if only a single mesh had been used, except that performance has been increased due to simultaneity of transmission.

Scenario (b) of FIG. 8 demonstrates that sequential packets p1 and p2 may actually propagate simultaneously, each on a different mesh, even though in the packet stream, packet p1 precedes p2. Notice that in timeslot T2, packets p1 and p2 propagate simultaneously from node 802 to node 803, and that during this timeslot, no packets propagate from node 801 to node 802. This is due to the fact that the channel A and channel B radios 805 and 806 respectively cannot receive packets while they are transmitting packets. Subsequently in timeslot T3, packets p3 and p4 propagate simultaneously from node 801 to node 802, while packets p1 and p2 propagate simultaneously from node 803 onward.

Scenario (c) demonstrates that it is not required for a packet to utilize multiple meshes in the interleaved scheme. A packet can propagate solely on one mesh if the mesh control software in the various nodes decides that this is appropriate under the particular circumstances. This choice could relate to traffic patterns and also to interference effects. In timeslot T1 of scenario (c), packet p1 propagates from node 801 to node 802 via the A-channel mesh. In timeslot T2 of scenario (c), packet p1 further propagates from node 802 to node 803, also via the A-channel mesh. In timeslot T3 of scenario (c), packet p1 propagates beyond node 803 to another node in the mesh, also via the A-channel mesh.

As described above, it has been demonstrated that a sequential stream of packets can be propagated faster through an interleaved mesh architecture compared with architectures having a single radio relay structure. As dictated by the current traffic situation, two sequential packets may be propagated in sequence on one mesh of the multiple available interleaved meshes, or alternately these same two sequential packets may be propagated simultaneously on different meshes within the multiple available meshes. In certain embodiments, it is necessary that these sequential packets are delivered to their final destination in proper sequence and hence it may be necessary to provide a buffer memory on the receiving side such that when packets are transmitted in parallel and received out of sequence, the proper sequence can be restored. This restoration of the packet sequence is performed by the controlling software in the receiving node which upon examining the identification field in the IP header of each packet, determines the proper sequence of packets stored in the buffer. Thus, the multiple meshes within an interleaved mesh architecture according to this invention are able to propagate a stream of sequential packets at a rate at least double the rate of a prior art mesh with single radio relay capability.

In reality, if omnidirectional antennas are used, the scenarios of FIG. 8 would look somewhat different when interference effects of adjacent nodes are further taken into account. These effects are described in more detail in FIG. 9. Here node 3 is transmitting 901 a packet to a node elsewhere on the mesh network, and while it is transmitting in this desired direction, as a result of using an omnidirectional antenna, the packet is also being transmitted in the opposite (undesired) direction 902 back towards node 2. Thus, while it would be desirable for node 2 to receive a packet from node 1 while node 3 is transmitting, such a packet transfer 903 is not possible and thus is shown with a “X” through it. As a result, node 1 is not able to transmit to node 2 but is able to receive 904 from some other node in the mesh network simultaneously with the transmission 901 from node 3. The result of this interference effect is that when examining a pipelined propagation of packets through a mesh with a 1-radio relay, only every third timeslot will actually propagate a packet, resulting in an actual propagated bandwidth of ⅓ that which the radios themselves are able to transmit and receive. Since this is a pipelined effect, after 4 hops the effect remains stable and the bandwidth degradation consistent. Of course most mesh installations are 2-dimensional topologies , not 1-dimensional as shown here for clarity. A 2-dimensional mesh will have further interference effects regardless of the architecture chosen. In the interleaved mesh according to this invention, much of this adjacent node degradation effect just described is offset by using multiple interleaved meshes to increase the simultaneity of packet propagation. In other words, by sending a packet stream simultaneously over two or more parallel meshes, the present invention can increase the overall effective propagation rate of a packet stream from the one third rate just described to a rate equal to two thirds or better of that which the radios themselves are able to transmit and receive. Note that the effect just described in FIG. 9 is the result of omnidirectional antennas which transmit in all directions, not just the desired direction. One object of this invention is to provide a directional mesh solution that provides packet propagation consistent with an interleaved mesh as described, but minimizes or eliminates the interference affects of FIG. 9 by implementing the interleaved mesh using directional or sector antennas (and sometimes additional radios) for fixed mesh installations where mesh nodes are more or less permanently mounted at a fixed location.

For mobile mesh applications such as police, fire department, and other first responders, as well as military applications, directional antennas are sometimes impractical and omnidirectional antennas must be utilized in spite of the limitations. Thus, FIG. 10 further describes packet propagation through an interleaved mesh specifically when omnidirectional antennas are utilized and adjacent node interference effects are present.

For scenario (a) in FIG. 10, timeslots T1 and T2 show packet propagation similar to scenario (a) of FIG. 8. In timeslot T3, a packet is unable to be transmitted 1001 from node 1002 to node 1003 due to interference 1004 from A-channel radio 1005 attempting to transmit 1006 packet p1 onward through the mesh. Packet p3 is finally able to propagate from node 1002 to node 1003 during timeslot T4. Notice that interfering transmissions 1007 and 1008 during timeslot T4 further impede packet propagation.

Scenario (b) in FIG. 10 starts with packets p1 and p2 being transmitted simultaneously during timeslot T1 from node 1002 to node 1003 on meshes A and B respectively within the interleaved mesh. During timeslot T2, these packets propagate further from node 1003 to node 1009. During timeslot T3, it would be desirable for packets p3 and p4 to be transmitted from node will 1002 to node 1003, however this is prevented by interference radiations 1010 and 1011 resulting from the transmission of p1 and p2 as shown. Finally, in timeslot T4, packets p3 and p4 are able to propagate from node 1002 to node 1003. Note that in scenario (b) of FIG. 10, packets p1 and p2 are transmitted simultaneously even though they are adjacent sequential packets in a particular packet stream. Thus, this particular packet stream is able to propagate at twice the rate that it would in a system with a conventional single radio relay, thereby increasing effective propagation rate of a single packet stream to at least ⅔ of that which the radios themselves are able to transmit and receive, when two parallel meshes are used for an interleaved scenario. This performance level includes the interference effects described for FIGS. 9 and 10.

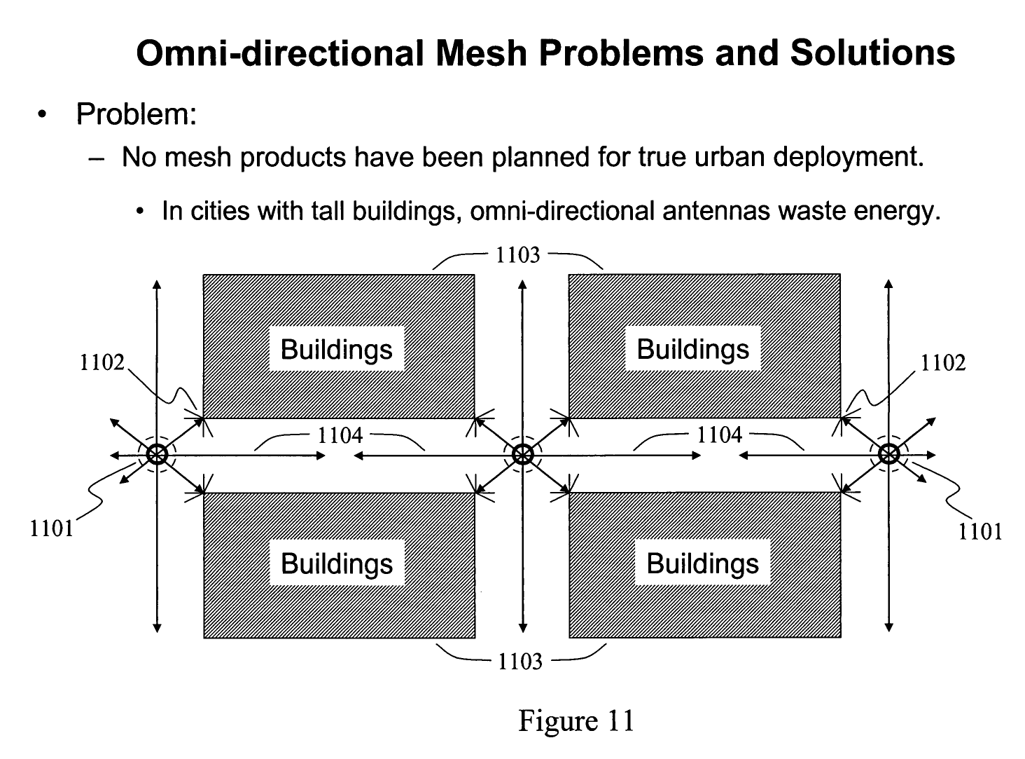

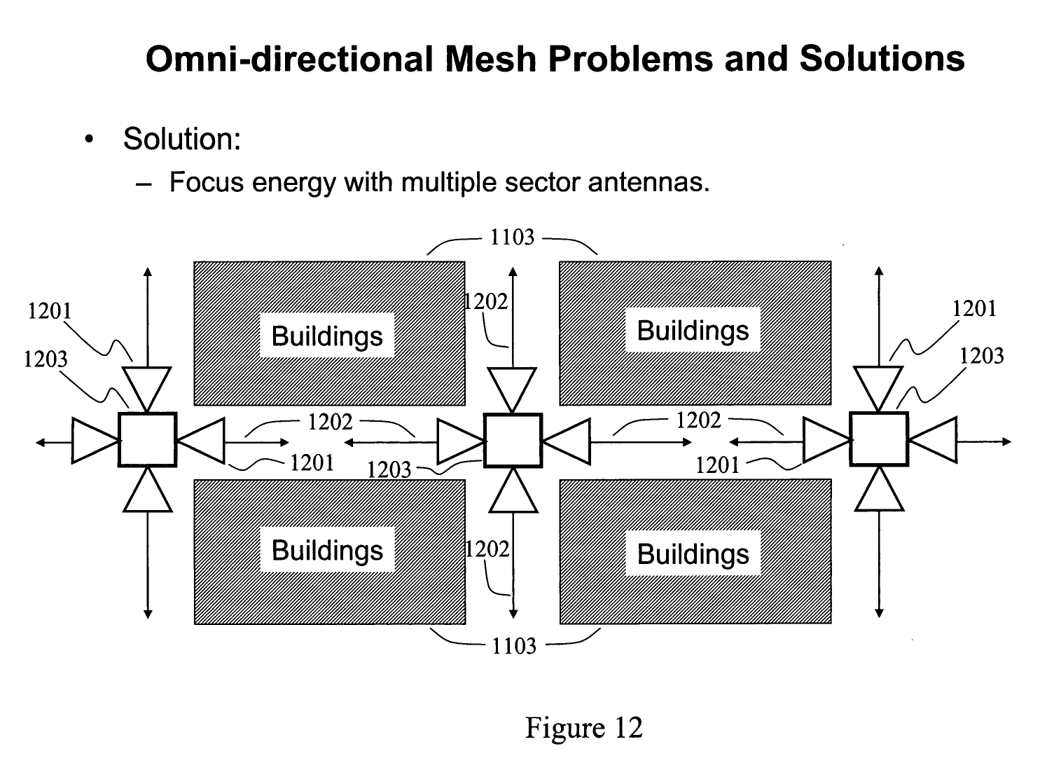

FIGS. 11 and 12 relate to deployment issues for mesh in urban applications. Today, most mesh nodes that are deployed utilize omnidirectional antennas. In urban applications, especially when tall buildings are present, omnidirectional antennas 1101 used for mesh relay radios waste most of their radiated energy as the wasted energy impinges 1102 on buildings 1103. Only a small portion 1104 of the radiated energy from a relay radio is actually directed toward an adjacent mesh node.

FIG. 12 demonstrates how directional or sector antennas can be utilized to focus a relatively narrow beam of radiated energy 1202 traveling between buildings 1103 to implement the communications link between relay radios 1201 on adjacent mesh nodes 1203.

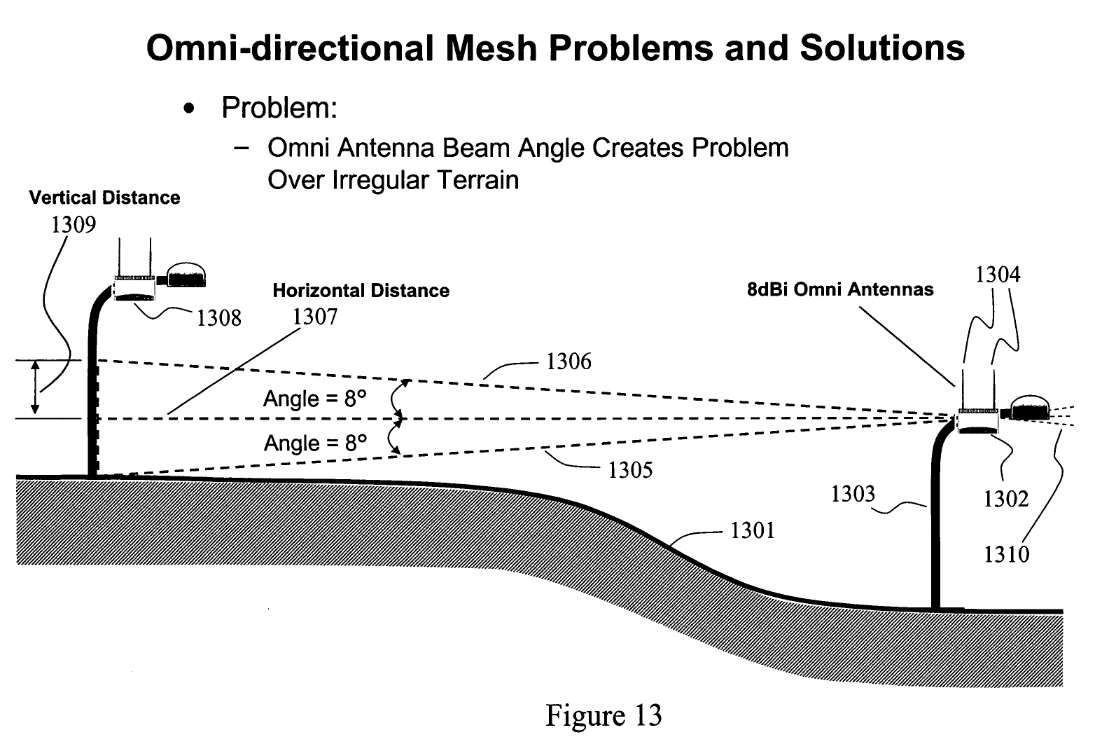

FIG. 13 demonstrates another problem that results when using omnidirectional antennas for relay radios on mesh nodes. Here, the mesh is deployed over terrain 1301 which is irregular in elevation. Mesh node 1302 mounted on a light pole 1303 has antennas 1304 which have been mounted to be vertical (the 2 antennas shown on each node in this figure are for diversity and are actually driven by a single radio). Assuming these antennas have a 16° vertical beam angle this means that the radiation pattern would fit within an envelope that extends between 8° below horizontal 1305 and 8° above horizontal 1306. Depending on the horizontal distance 1307 between mesh node 1302 and an adjacent mesh node 1308, the vertical distance 1309 defining the vertical envelope of the radiation pattern from node 1302 as viewed at the location of node 1308 may be too small to allow the radiation pattern to reach mesh node 1308. As a result, node 1302 and node 1308 may be unable to communicate. If antennas 1304 on node 1302 were instead tilted to allow the upper edge 1306 of the radiation pattern to reach note 1308, radiation patterns 1310 from node 1302 emanating in the opposite direction would be automatically tilted towards the ground, and as a result would be unable to connect to other mesh nodes in the opposite direction.

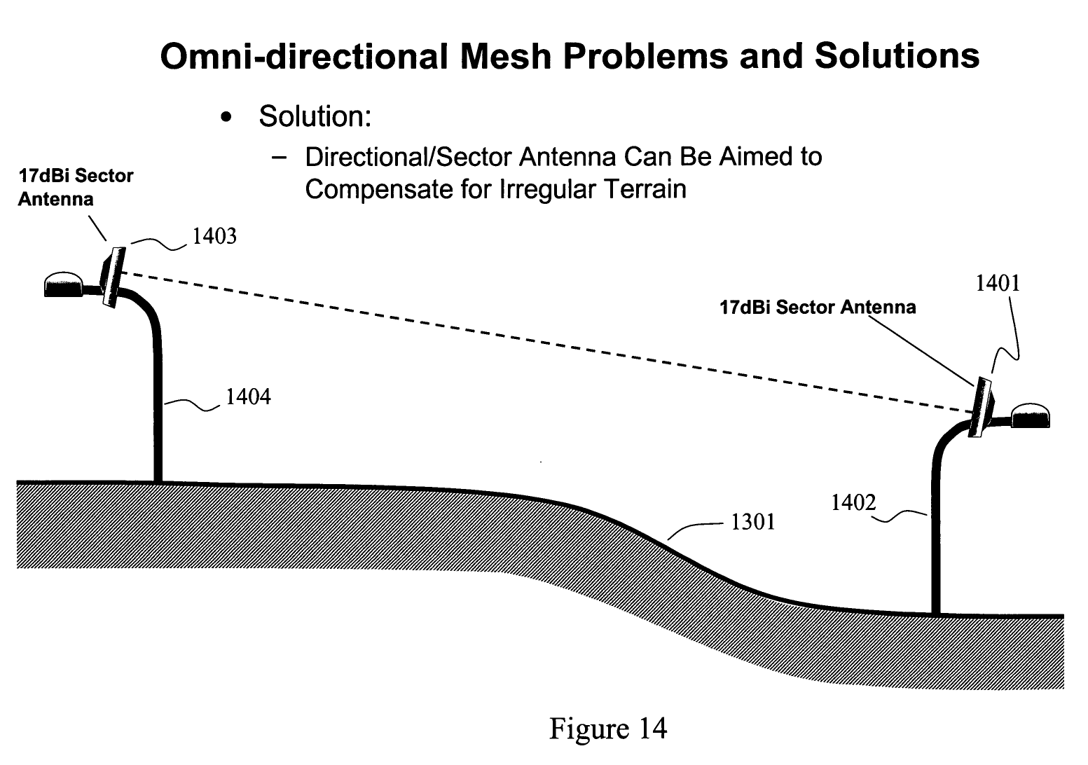

FIG. 14 shows how directional or sector antennas offer a solution to the problem of irregular terrain as demonstrated in FIG. 13. Here, sector antenna 1401 functions in conjunction with a relay radio connected to a mesh node on a light pole 1402. Antenna 1401 is adjustable for both azimuth and elevation enabling it to be vertically tilted to be aimed directly at antenna 1403 which is connected to a mesh node mounted on light pole 1404. Both antennas 1401 and 1403 are adjusted such that and they are aimed directly at each other thereby compensating for any variation in the elevation of terrain 1301. Note that additional sector antennas mounted on the same light poles can be aimed in other directions and adjusted differently for elevation in order to deal with further terrain irregularities.

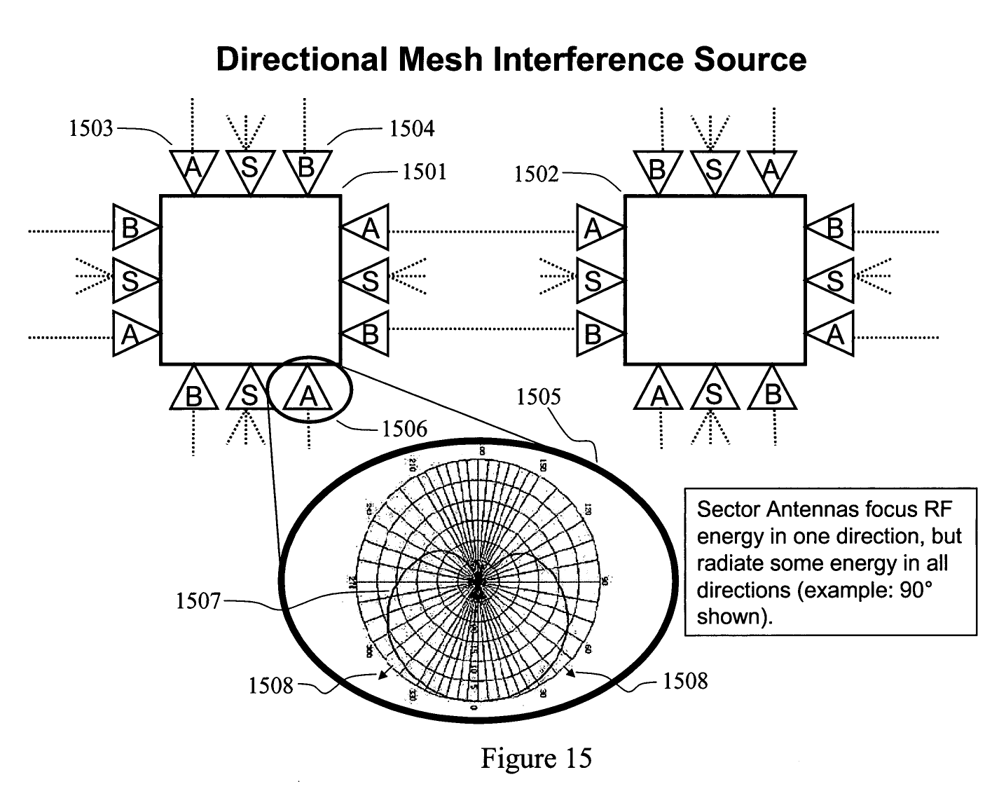

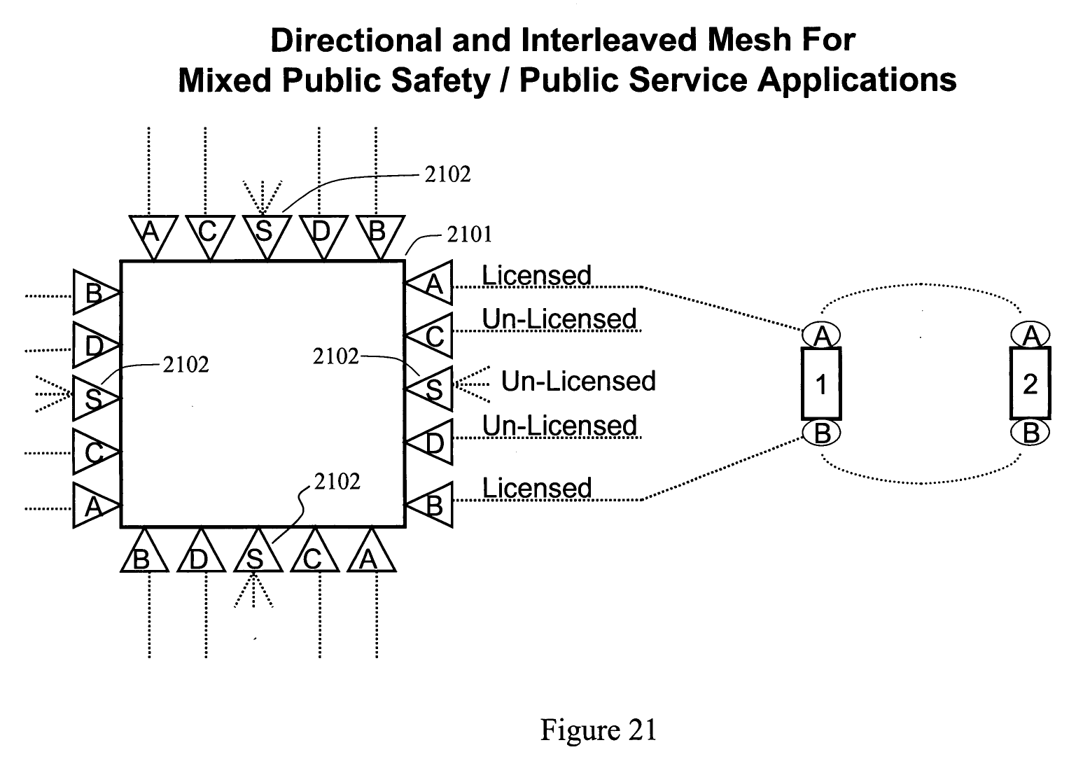

FIG. 15 shows two nodes 1501 and 1502 of a directional interleaved mesh according to this invention where multiple sector antennas are used in each of the four substantially orthogonal directions. (Note that where “orthogonal” is used in this specification to describe relative directionality, it means “substantially orthogonal” since there would typically be minor adjustments for azimuth and elevation of antennas to adjust for specific topological requirements.) Such nodes would be typically used in fixed locations within what would be typically called a fixed wireless mesh (as opposed to a mobile mesh). The channel assignments for the radios connected to each antenna are shown as letters within the antenna symbols such as A-channel antenna 1503 and B-channel antenna 1504. Notice that for each mesh node there is at least one antenna in each direction dedicated to channel A and another to channel B. This arrangement essentially replicates the interleaved mesh of FIG. 7 except that in each direction energy can now be focused more accurately. However if independent radios are connected to each of the antennas of mesh nodes 1501 and 1502, much higher performance is possible (due to simultaneity of transmit and receive) once solutions to the interference challenges have been implemented. A number of the figures that follow describe different strategies per the present invention for dealing with interference issues at a node, and provide varying degrees of increased performance. Regardless, note that in supporting both the A-channel mesh and the B-channel mesh of an interleaved mesh according to this invention, the fixed directional mesh nodes of FIG. 15 will communicate properly with mobile mesh nodes using omnidirectional antennas, should such mobile mesh nodes utilize the interleaved mesh architecture of FIGS. 5, 6, and 7. Communication between fixed and mobile mesh nodes in this fashion will be further discussed starting with FIG. 21.

Regarding the interference issues which arise once multiple antennas are placed in close proximity to one another and driven by radios operating on the same channel (co-channel operation), the enlargement 1505 of A-channel radio 1506 in FIG. 15 shows the horizontal radiation pattern 1507 typical of 90° sector antennas. Notice that the radiation pattern is reduced by 3 dB from its maximum at points 1508 which are 45° from the primary direction of the antenna. Also notice that even though most of the energy is focused in the primary direction, there is still considerable radiation throughout the remainder of the 180° span of the primary direction, and in fact some radiation is still present in a reverse direction. While this graph tends to indicate that little or no radiation is present directly opposite the primary direction, in fact most sector antennas have a specification called “front to back ratio” which is typically greater than 25 dB. However, even a signal that is 25 dB lower than the primary transmission may interfere with reception at other co-located antennas operating on the same channel depending on shielding and RF filtering characteristics. This explanation should therefore demonstrate why these co-channel interference issues should be addressed if fixed mesh nodes are to be constructed using multiple antennas with independent radios operating on the same channel.

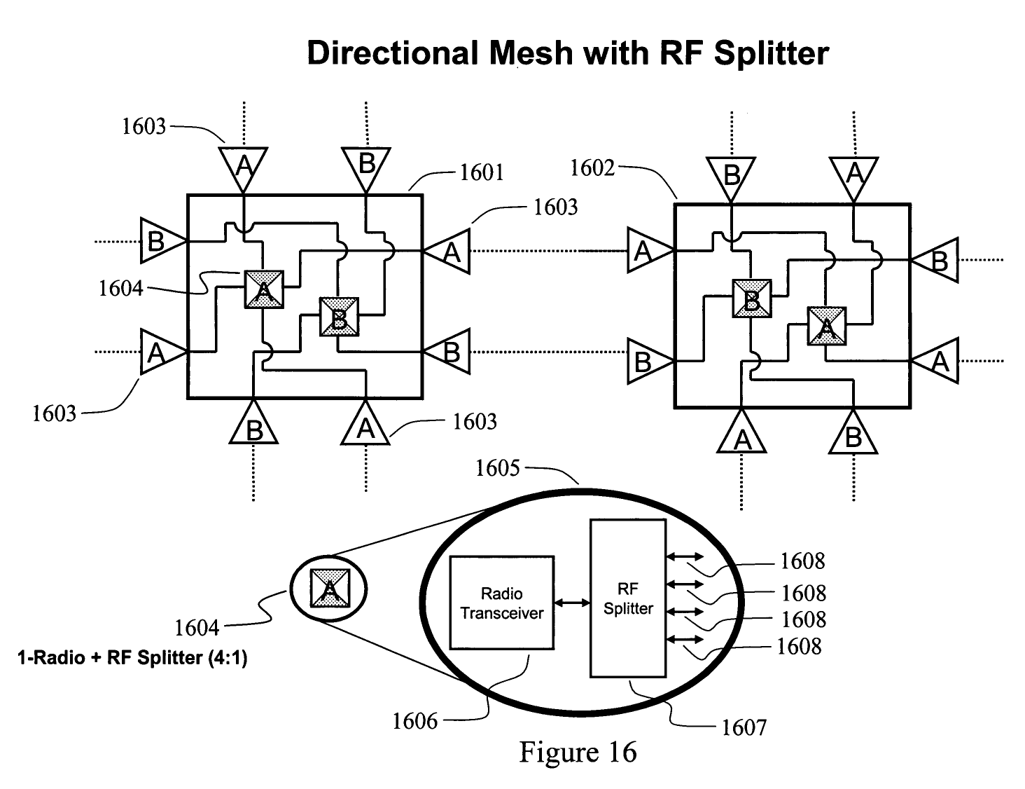

FIG. 16 shows a variation on the directional mesh of FIG. 15 and solves the co-channel interference problem by ensuring that all antennas on the same node and assigned the same channel are either transmitting or receiving simultaneously. Mesh nodes 1601 and 1602 are similar to nodes 1501 and 1502 but include provision for all A-channel antennas 1603 on a particular node to be driven by a single common radio. This is accomplished by combination radio/splitter 1604 which is shown in greater detail in enlargement 1605 where radio transceiver 1606 feeds RF splitter 1607 which divides the RF energy into four outputs 1608, each of these outputs going to one of antennas 1603. In this manner the four common channel antennas 1603 function in unison as if they were an omnidirectional antenna. Depending upon the horizontal beam width of each antenna, there can be gaps in the horizontal radiation pattern if each sector antenna has a beam width angle of less than 90°. However, if each antenna is a 90° sector antenna, the four antennas 1603 will exactly cover 360°. In the urban environment however we know that such a distribution will cause the majority the energy to impinge on buildings and be wasted. Thus, in a dense urban environment each of antennas 1603 could be chosen to have a more narrow beamwidth, for instance 45° or even 30° or less, thereby focusing transmit energy in the direction of other mesh nodes to which packets are to be relayed.

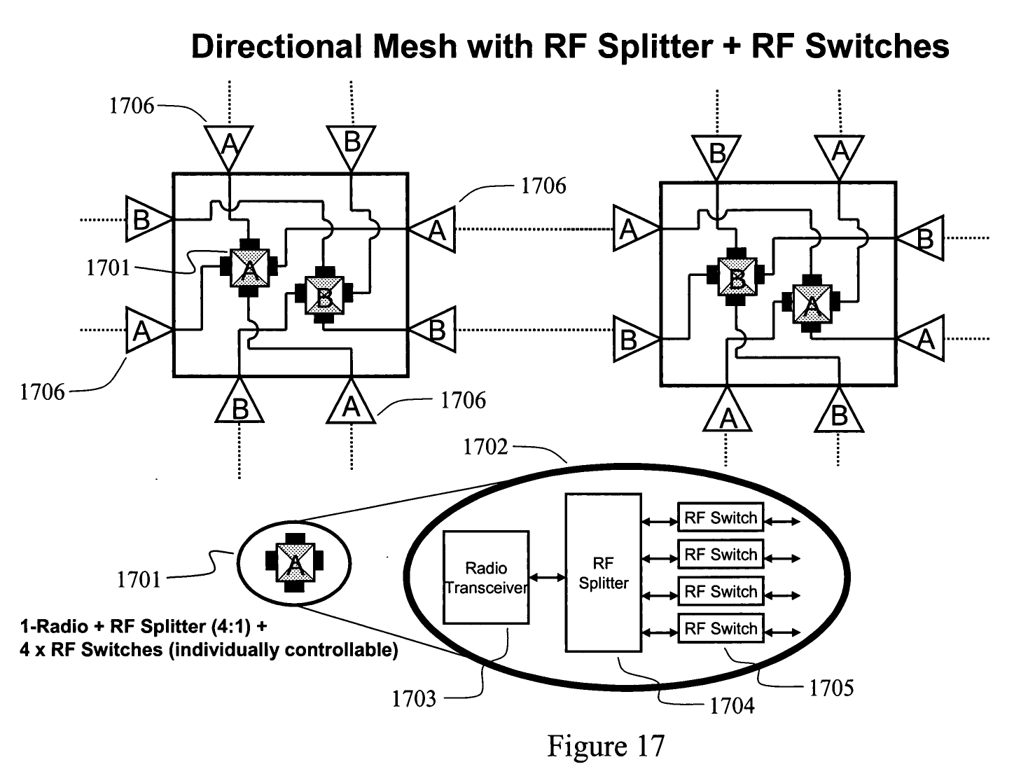

FIG. 17 shows a variation on the directional mesh node of FIG. 16 where individually controllable RF switches have been added as part of radio splitter combination 1701. Enlargement 1702 shows this combined functionality where radio transceiver 1703 feeds RF splitter 1704, the four outputs of which feed four individually controllable RF switches 1705 which in turn drive four common channel antennas 1706. The goal of this added functionality is to prevent the interference effect described in FIG. 9 from reducing performance of a mesh based on the node structure of FIG. 17. This is accomplished by controlling RF switches 1705 such that they only allow transmissions to pass when, in fact, it is desired to move packets in the specific direction associated with the particular antenna 1706. Thus, the adjacent node interference effect and degradation suffered by mesh architectures based on omnidirectional antennas and described in FIG. 9 will be avoided since the equivalent of transmission 902 in FIG. 9 will be blocked or prevented by a particular RF switch 1705.

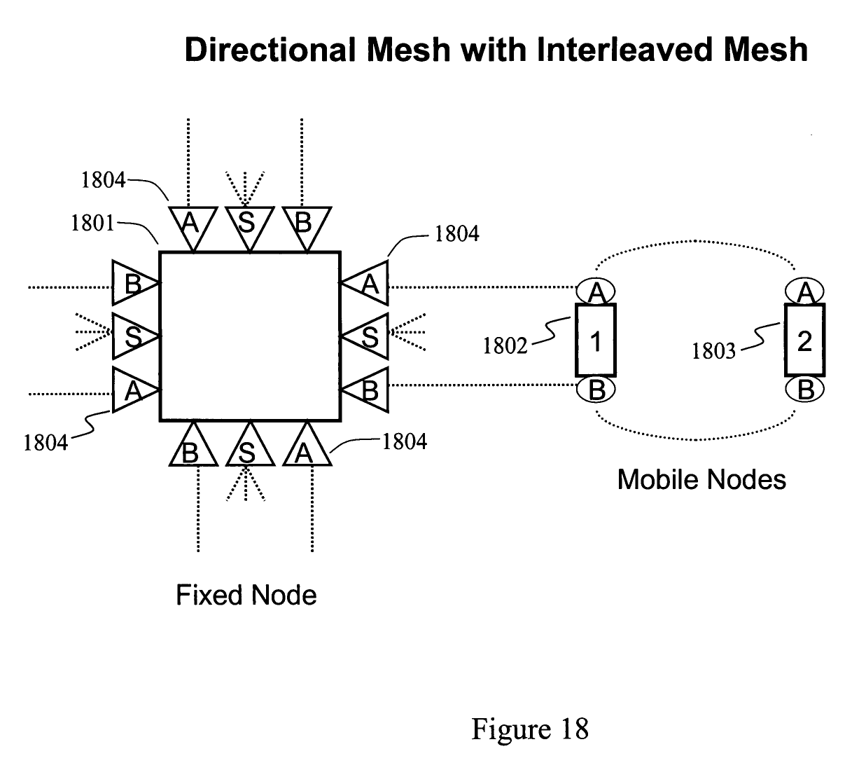

FIG. 18 shows how the directional mesh nodes of FIGS. 15-17 can be combined with the interleaved architecture of FIG. 6, as in Public Safety applications where directional node 1801 would be fixed and nodes 1802 and 1803 would be mobile. Notice that for instance, A-channel radios 1804 on fixed node 1801 are all capable of connecting to the A-channel radios on nodes 1802 and 1803. The B-channel radios on these same fixed and mobile nodes are capable of connecting in a like manner.

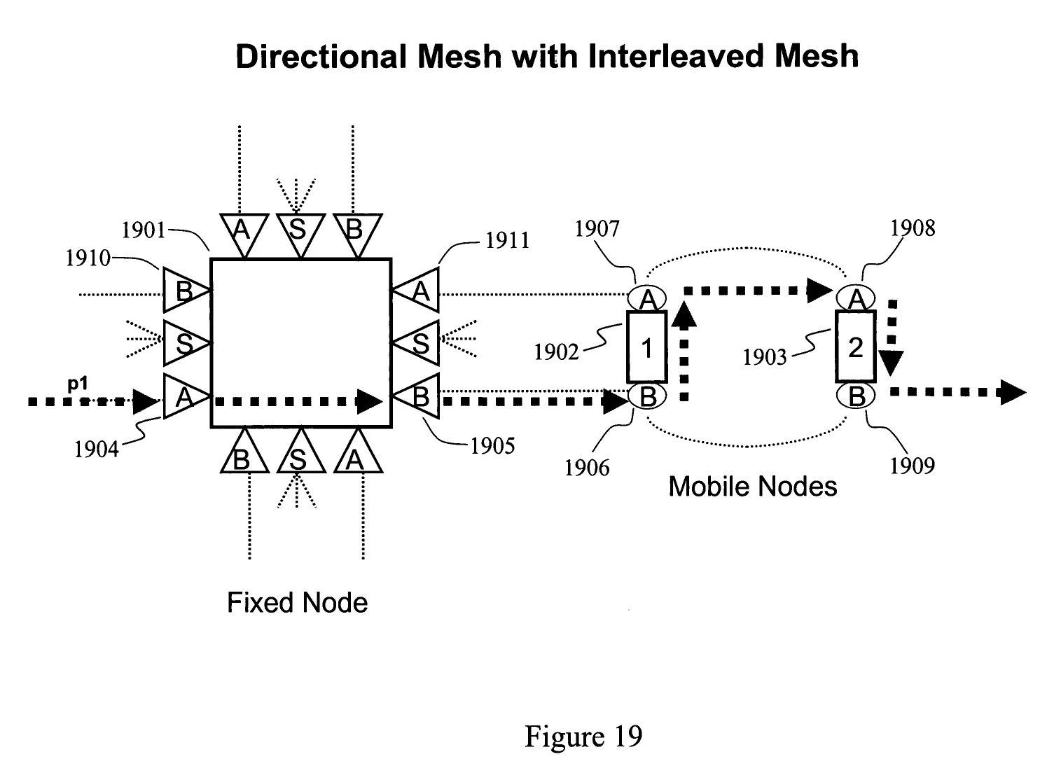

FIG. 19 shows a possible packet data path for the combined mesh of FIG. 18. Initially, packet p1 might enter fixed node 1901 on A-channel radio 1904. After being processed in node 1901, packet p1 could then be transmitted on B-channel radio 1905 being received by B-channel radio 1906 on mobile node 1902. Subsequently, this same packet p1 could be transmitted on A-channel radio 1907 being received by A-channel radio 1908 on mobile node 1903. Finally, p1 could be further transmitted by node 1903 via B-channel radio 1909. Other packet data path scenarios are possible, this is simply an example of one. However, it shows how fixed nodes having directional mesh construction with multiple sector or directional antennas can be used in unison with mobile nodes having omnidirectional antennas, the combination functioning as a unified interleaved mesh according to this invention where multiple meshes are used to propagate a single packet stream. This combination of directional and interleaved mesh is one of the fundamental embodiments of the present invention.

For FIG. 19, note that at a different moment in time, another packet could enter node 1901 on B-channel radio 1910 and then leave node 1901 on B channel radio 1905. Alternately, a packet could enter via B-channel radio 1910 and exit via A-channel radio 1911 which is also capable of communicating with node 1902 via A-channel radio 1907. Which paths are used at any moment will depend on the packet traffic that is present and the path assignment algorithm.

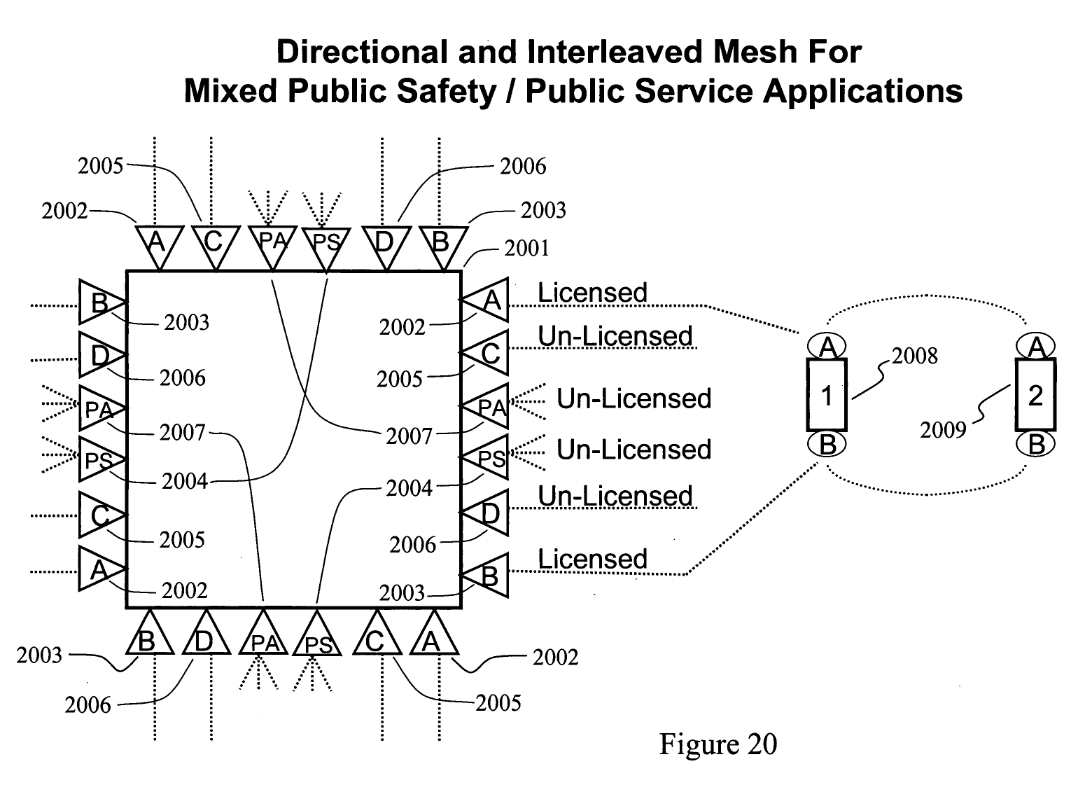

FIG. 20 shows a mesh supporting both Public Safety and general Public Access service where both licensed and un-licensed frequencies are used. As mentioned previously, frequencies such as 4.9 gigahertz require a license and may be used only for public safety related traffic by public safety agencies such as police, fire department, EMT, and Homeland Security. Fixed mesh node 2001 in FIG. 20, shows a relatively full complement of radios for supporting both public safety and public access wireless networking requirements. The public safety mesh is implemented as an interleaved mesh using A-channel and B-channel radios 2002 and 2003. As mentioned previously, different implementations can be constructed such that the antennas for 2002 and 2003 are driven by either separate individual radios or a common radio using a splitter. Local service to client radios for public safety purposes is supplied by radio 2004.

Mesh support for general public access needs is implemented as a separate interleaved mesh utilizing C-channel radios 2005 and D-channel radios 2006. Local service to support client radios for public access is supplied by radio 2007. The interleaved mesh supported by A-channel radio 2002 and B-channel radio 2003, and typically operating on a licensed public safety band, interfaces with the interleaved mesh implemented for mobile nodes 2008 and 2009 such that for public safety applications these fixed and mobile nodes operate in unison as a single interleaved mesh. Note that for a network such as that shown in FIG. 20 supporting both public safety and public access, that even though public access traffic (general traffic between typical citizens and the Internet) is never allowed to travel on a public safety band or frequency, in an emergency situation it may be valuable and appropriate for some public safety traffic to travel on frequencies or channels normally used only for public access.

FIG. 21 shows a mesh network similar to the system of FIG. 20 except that the public safety service radio on fixed node 2101 has been removed. This might be the case in certain public safety applications where all radios are desired to participate in the mesh as relay nodes. In this figure, service radios 2102 for public access support are retained. FIG. 21 simply demonstrates that various subsets of capability may be utilized depending upon the needs of a particular installation.

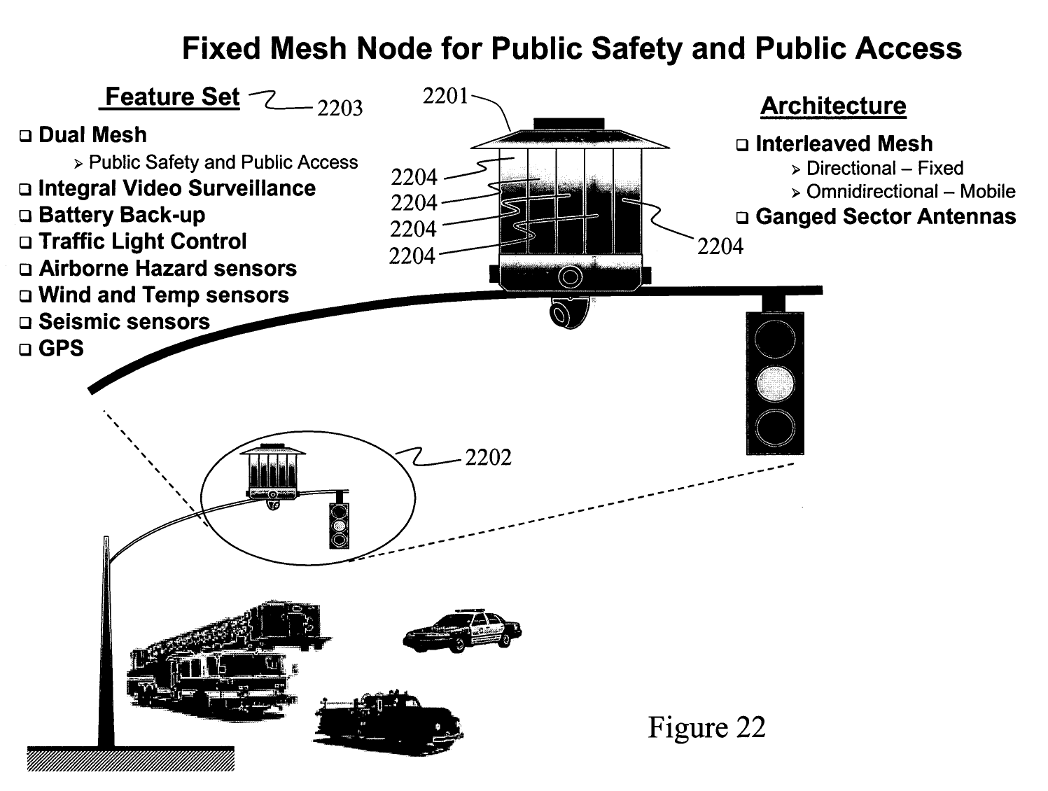

FIG. 22 shows what fixed directional interleaved mesh node 2101 of FIG. 21 might look like in an actual real world installation. Here, such a mesh node 2201 is shown mounted at traffic intersection 2202. In addition to supporting WiFi service for general public access applications, such a mesh node can support a variety of public service capabilities such as those listed in feature set 2203, including, either integral with or attached to node 2101, various sensors for video surveillance and airborne hazardous materials as well as seismic and wind sensors. The inclusion of these and other appropriate public safety-related sensors enables a grid of such mesh nodes to effectively form a comprehensive sensor network covering a metropolitan area. Supported by a battery backup system, such a node can also control traffic signals in the event of an emergency situation where today, such traffic signals would cease to function.

As shown in FIG. 22 four groups of five sector antennas are utilized. Each group of sector antennas 2204 can be implemented as a gang of antennas which have a fixed relationship to each other and can be adjusted for azimuth and elevation in unison.

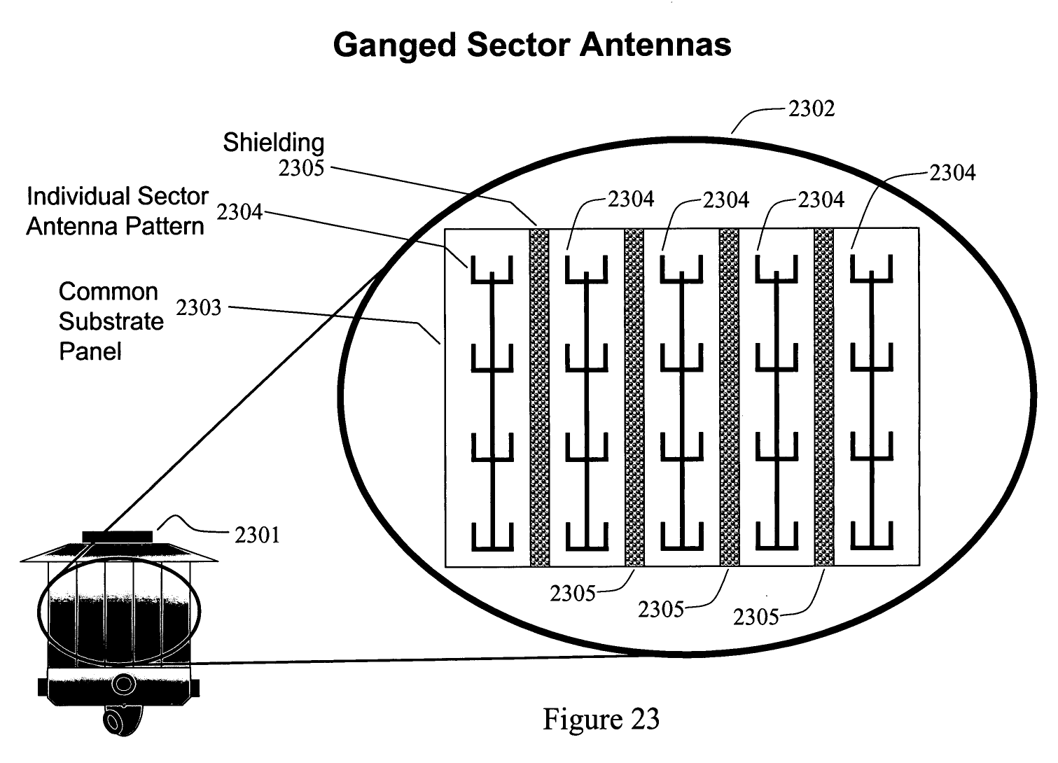

FIG. 23 shows fixed directional interleaved mesh node 2301 which is similar to mesh node 2201 of FIG. 22 and contains four ganged sector antennas, each antenna gang appearing as shown in enlargement 2302. Each antenna gang may be constructed on a common substrate panel 2303 which may consist of a standard printed circuit board (PCB) substrate material such as FR4 or other suitable material. Individual sector antenna conductor patterns can then be constructed simultaneously during the printed circuit board fabrication process to produce five individual antennas 2304 on one common PCB substrate 2303. Connections for shielding 2305 can be included in the conductor patterns created on PCB substrate 2303, and additional conductive material suitable for RF shielding can be mounted to PCB substrate 2303 at locations 2305 to provide additional shielding between individual antenna patterns 2304. In addition, other shielding measures can be provided within the overall enclosure of fixed mesh unit 2301 to further isolate each ganged sector antenna panel from the others in the enclosure. Note that to support MIMO (Multiple Input Multiple Output) radio-antenna combinations, the ganged antenna structure of FIG. 23 could be modified to include multiple antenna element patterns in place of each of patterns 2304 in FIG. 23.

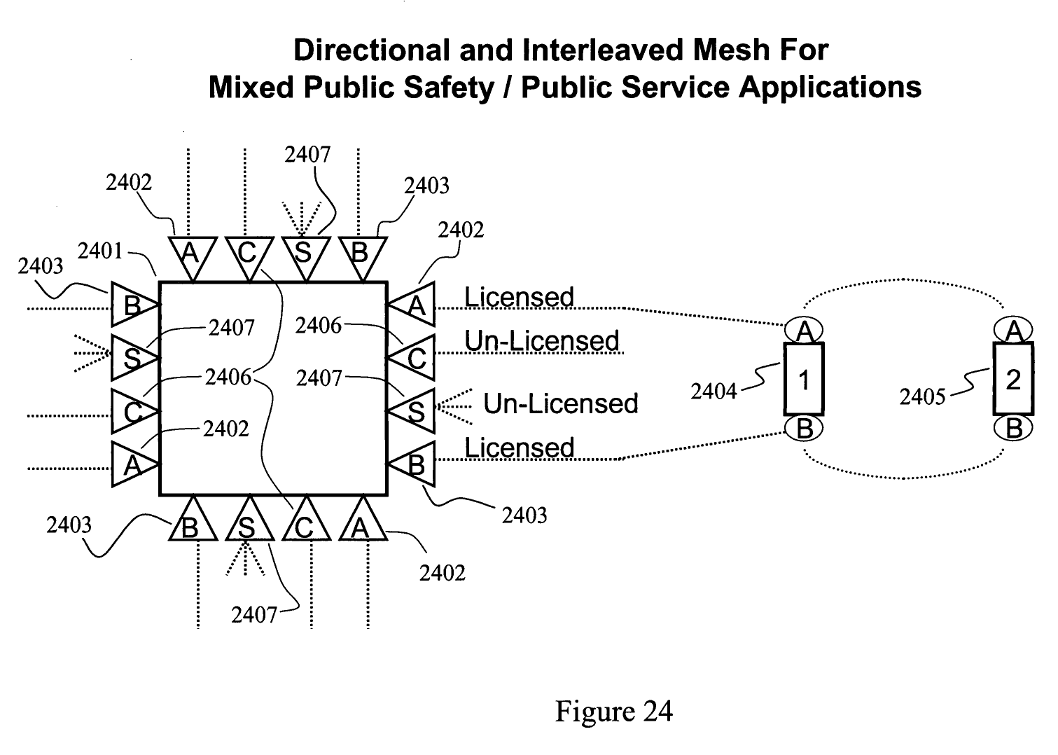

FIG. 24 is another example of how the more complex system of FIG. 20 might be depopulated for some applications which require a simpler solution. Here, fixed node 2401 still has an interleaved mesh implemented with A-channel radios 2402 and B-channel radios 2403, in this instance supporting the licensed public safety band. Public safety relay radios 2402 and 2403 are capable of communicating with mobile public safety nodes 2404 and 2405 according to an interleaved mesh functionality as described herein. For public access, FIG. 24 shows only a single relay radio 2406 per fixed mesh node 2401. This is implemented with C-channel radios 2406 which would typically operate on an unlicensed band. A service radio for public access is included and implemented with S-channel radios 2407. FIG. 24 demonstrates that an interleaved mesh according to this invention can be used for portions of the functionality within a mesh node, while a more conventional mesh architecture may be used for other portions of the overall functionality, in this case a “1+1” mesh (non-interleaved) per FIG. 1(c) where a single radio relay is used in conjunction with a separate service radio on each mesh node for public access functionality.

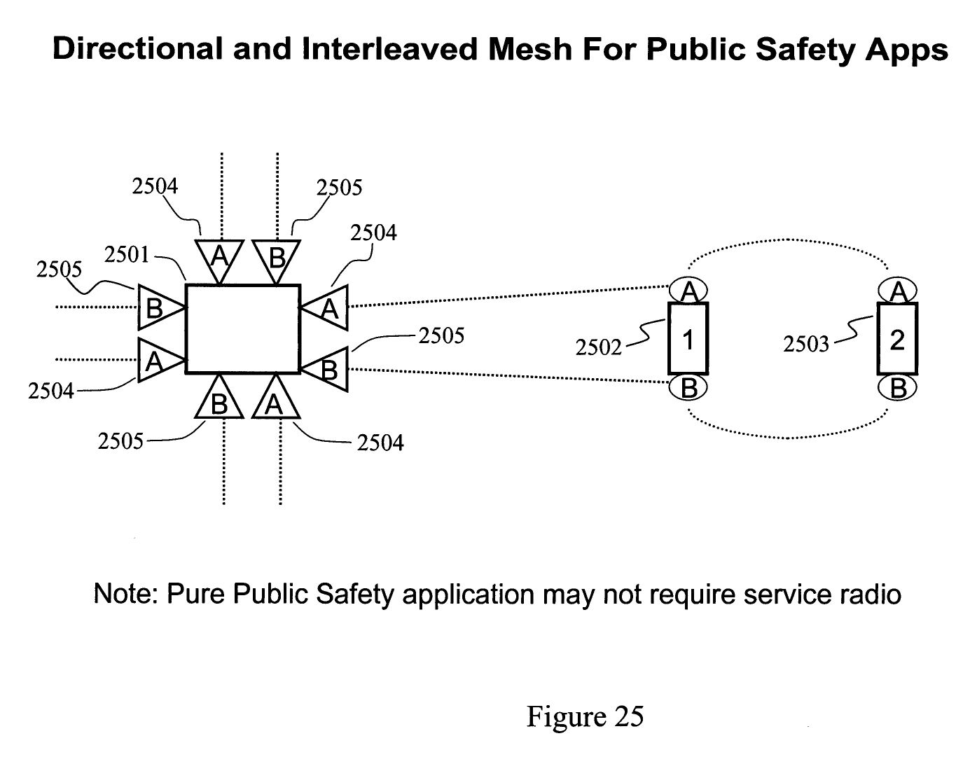

FIG. 25 shows yet another subset of the functionality of FIG. 20. Here fixed mesh node 2501 supports only public safety requirements and includes no service radio. Yet, mesh node 2501 still communicates properly via an interleaved mesh architecture with mobile nodes 2502 and 2503 by way of A-channel radios 2504 and B-channel radios 2505.

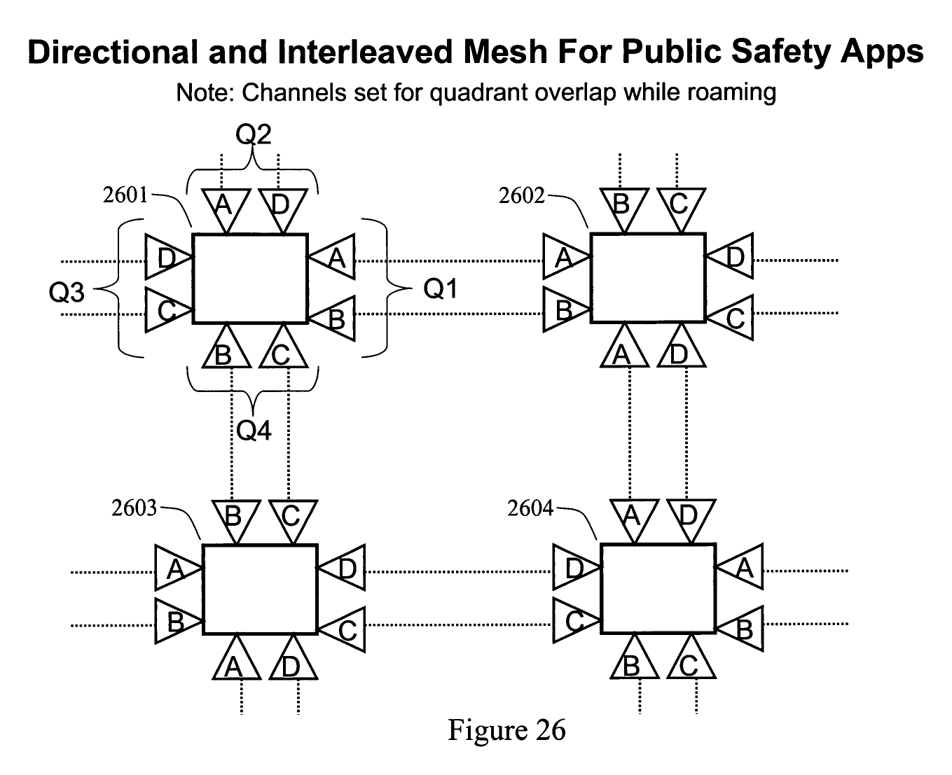

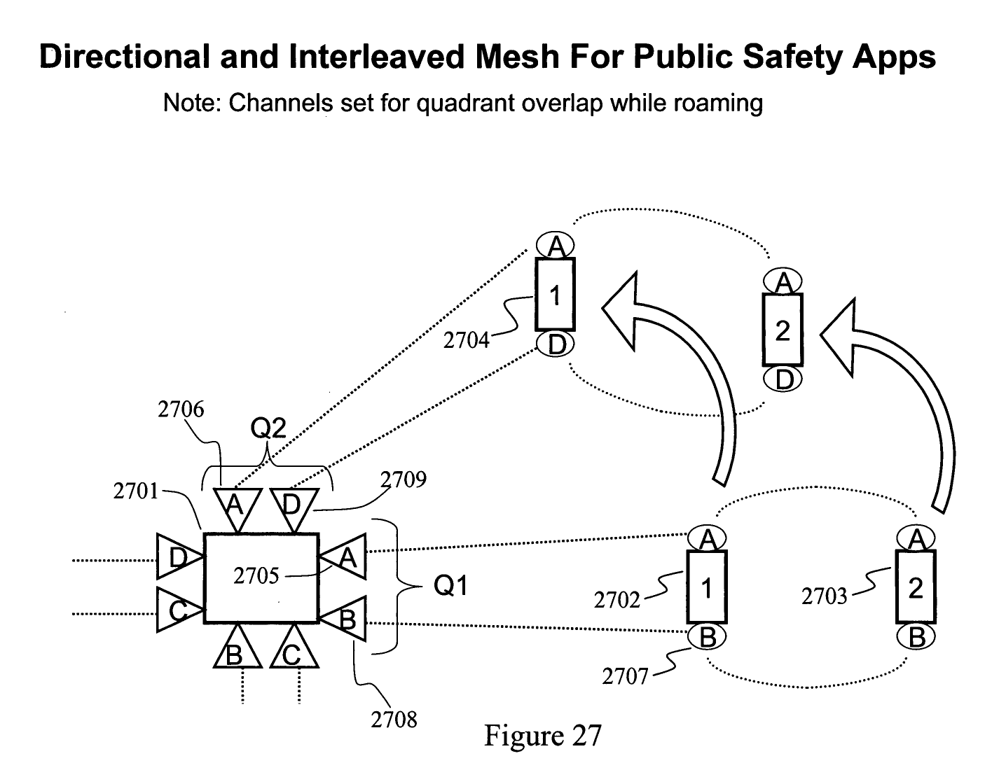

FIG. 26 shows a grid of fixed directional mesh nodes having interleaved mesh capability, but where channel assignments have been done somewhat differently than those shown earlier in this application. Note that channel assignments have been done such that alternating mesh nodes in the grid such as mesh nodes 2601 and 2603 have their channel assignments arranged differently, while mesh nodes arranged diagonally in the grid, such as nodes 2602 and 2603 have their channel assignments arranged identically. Notice as shown for node 2601, adjacent quadrants always have one channel assignment in common. For instance, quadrants Q1 and Q2 both have a radio assigned to channel A, while quadrants Q3 and Q4 both have a radio assigned to channel C. The two radios in each of the four quadrant directions are utilized for a packet propagation scheme consistent with an interleaved mesh as defined earlier in this application. The reason for the somewhat unusual channel assignment on each node in FIG. 26 results from one strategy to reduce co-channel interference on any particular directional mesh node, while still providing the ability to interface with mobile nodes in an interleaved fashion as will be described further in FIG. 27. The strategy here becomes more apparent if one views directional mesh nodes such as 2601 on a quadrant by quadrant basis. Notice for instance that quadrant Q1 on node 2601 has radios assigned using channels A and B. Moving counterclockwise, quadrant Q2 utilizes channels A and D, channel A being common to both quadrants. Moving further around node 2601 in the counterclockwise direction, we see that quadrant Q3 utilizes channels C and D, channel D being common to adjacent quadrants Q2 and Q3. Completing the tour, quadrant Q4 utilizes channels B and C, channel C being common to adjacent quadrants Q3 and Q4, with channel B being common to adjacent quadrants Q4 and Q1. Thus, it can be seen that one channel is always common to adjacent quadrants.

FIG. 27 shows how mobile mesh nodes 2702 and 2703 take advantage of the channel assignment just described for FIG. 26 when for example these mobile nodes move counterclockwise around fixed directional mesh node 2701. Initially the mobile mesh node at position 2702 communicates with node 2701 via channels A and B in an interleaved fashion. Subsequently this mobile mesh node 2702 moves to a new position 2704 where eventually its A-channel radio disengages with radio 2705 on node 2701 and reengages with radio 2706 in a smooth transition without having to re-scan since both connections are on the A-channel. During this transition, B-channel radio 2707 on node 2702 will eventually lose contact with radio 2708 on node 2701, re-scan for other channels, and upon entering quadrant Q2 will reestablish contact with node 2701 by communicating on channel D with radio 2709. Thus, as a mobile node moves from quadrant to quadrant in relation to a fixed directional mesh node according to FIG. 27, at least one radio on the mobile mesh node will always have continuous communication with the fixed mesh node.

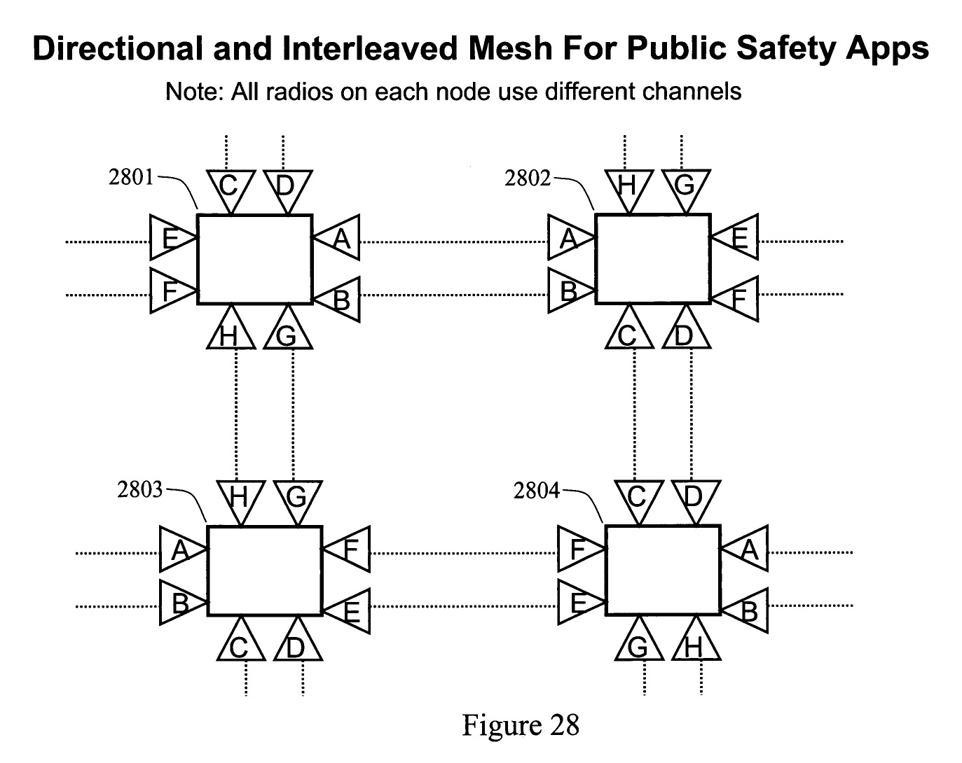

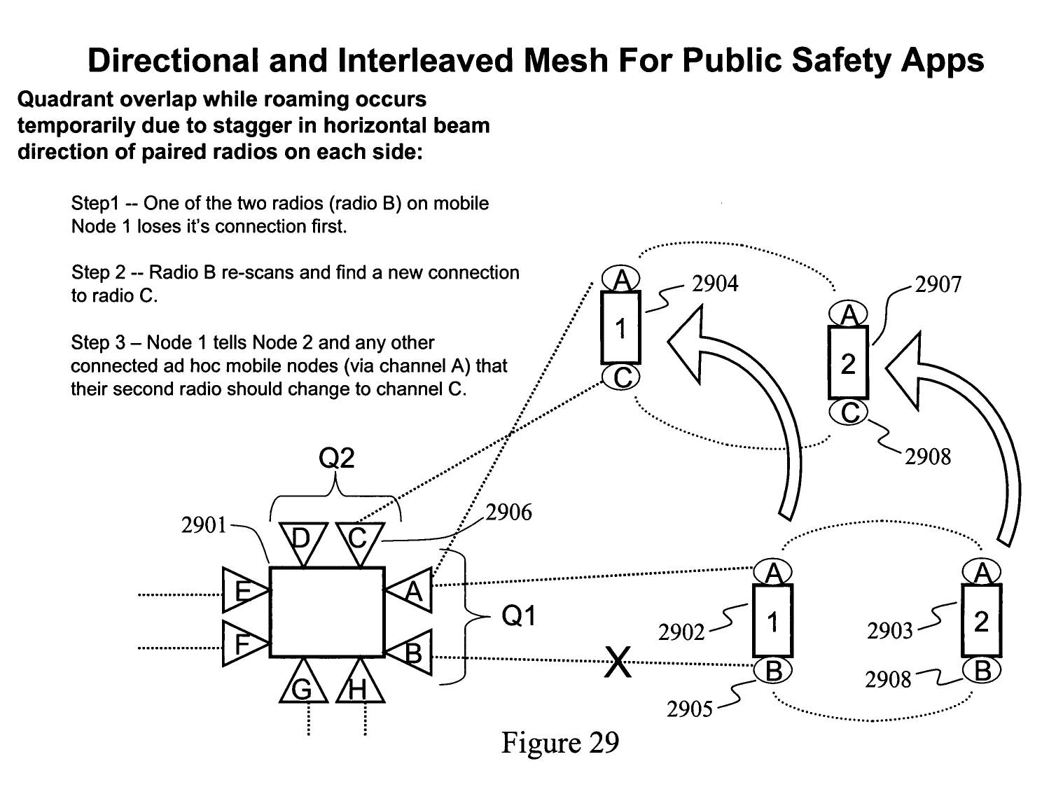

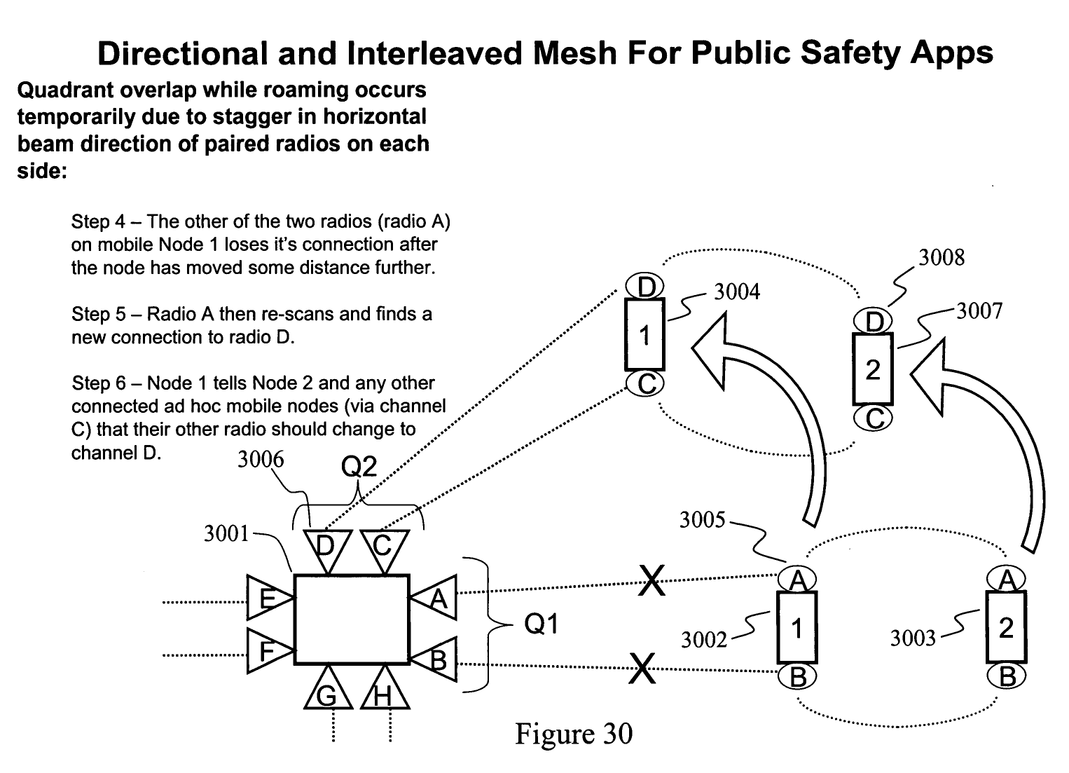

FIG. 28 shows yet another channel assignment strategy for a grid of fixed directional mesh nodes. In a manner similar to the grid of FIG. 26, notice that nodes 2801 and 2804, which are positioned diagonally in the grid, have identical channel assignments as do nodes 2802 and 2803. In contrast with the grid of FIG. 26 however, notice that all of the radios on a given node in FIG. 28 have been assigned different channels. Thus, there would be no co-channel interference on any individual mesh node. Notice that from the perspective of an individual node such as 2801, in any given direction there are always two radios available to transmit and receive packets thereby enabling an interleaved mesh architecture to the implemented. Communicating between the fixed directional mesh nodes of FIG. 28 and mobile mesh nodes (with omnidirectional antennas) becomes more challenging however, as will be shown in FIGS. 29 and 30.

FIG. 29 demonstrates how mobile nodes such as 2902 and 2903 move relative to a fixed directional mesh node such as 2901, and how wireless connectivity is maintained during the transition where node 2902 leaves quadrant Q1 and enters quadrant Q2. For this particular strategy to function smoothly it is important that one of the two radios on node 2902 disengages its connection with node 2901 before the other radio. In step 1 of FIG. 29, the B-channel radio 2905 on node 2902 loses its connection with node 2901 first. In step 2, radio 2905 re-scans and subsequently engages with C-channel radio 2906 on node 2901 as node 2902 has moved to position 2904. In step 3, mobile node 2904 then tells the other connected mobile node 2907 (via the still connected A-channel radios) to change its B-channel radio 2908 to channel C. There is an inherent assumption in this strategy that the radios on node 2901 are either directionally staggered, varied in power output, or somehow otherwise implemented such that the connection to one of them will disengage before the other, such that at least one of the radios on mobile nodes 2902 will remain connected at any point in time as it moves toward position 2904. In reality, there may be natural differences in any pair of radios such that one will always disengage before the other regardless of any design implementation.

The sequence of FIG. 29 continues in FIG. 30. In step 4, A-channel radio 3005 on node 3002 eventually disengages from node 3001, rescans (step 5) and subsequently reengages with node 3001 on channel D having connected with radio 3006. In step 6, node 3004 tells node 3003 which is now moved to position 3007 (via their C-channel connection) that this channel change has occurred and that node 3007 should change its A-channel radio 3008 to channel D.

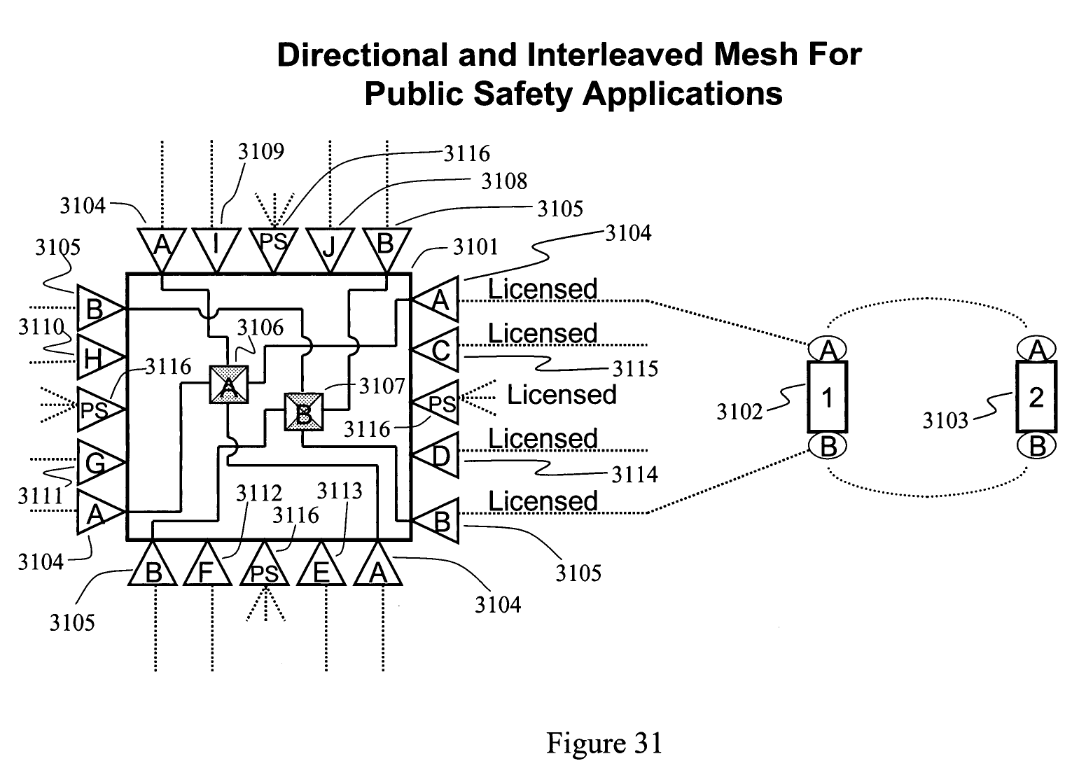

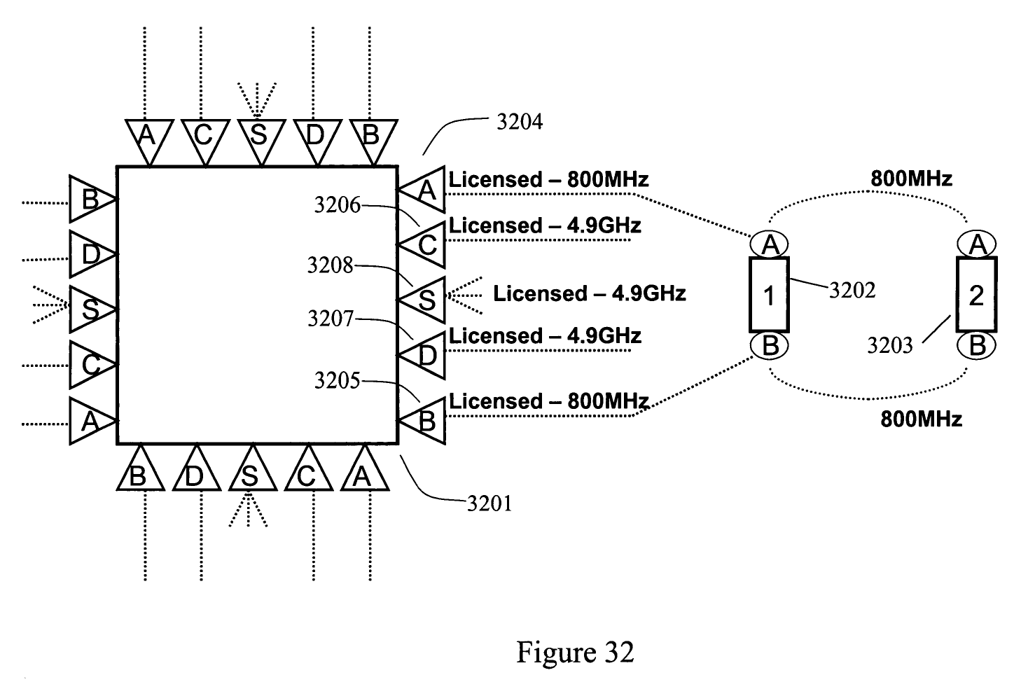

Obviously, the sequence shown in FIGS. 29 and 30 adds complexity to the process of making RF connections from a mobile node to a fixed directional node as the mobile node moves from quadrant to quadrant. One way to avoid this additional complexity is to separate the interface to the mobile mesh from the fixed mesh itself. An interleaved mesh network that demonstrates this alternative is shown in FIG. 31, and in this case is shown supporting public safety only (for simplicity). Fixed interleaved mesh node 3101 interfaces with mobile nodes 3102 and 3103, making RF connections to the fixed node on A-channel antenna 3104 and B-channel antenna 3105. In order to create a smooth transition as mobile nodes 3102 and 3103 move from one quadrant of node 3101 to another, the four orthogonal antennas 3104 are connected to a common A-channel radio 3106 in the manner previously shown in FIG. 16. Likewise the four orthogonal antennas 3105 are connected to a common B-channel radio 3107. The inclusion of individual RF switches between these common radios and each set of four antennas is also possible as previously shown in FIG. 17.

As an alternative to utilizing directional antennas on fixed node 3101 for communicating with mobile nodes 3102 and 3103, each of radios 3106 and 3107 may also be connected to a single omnidirectional antenna mounted on fixed node 3101. This may simplify fixed node 3101 and where the frequencies for mobile communication are low enough to successfully penetrate buildings (such as the 700-900 MHz range), having an omnidirectional antenna radiating in all directions may actually be desired.

While FIG. 31 shows two mobile relay radios 3106 and 3107 for communicating with mobile nodes 3102 and 3103, an alternative would be to implement the mobile relay radios with at least four radio antenna combinations per channel, such as 3204 and 3205, utilizing directional antennas as shown in FIG. 32, essentially in a manner similar to FIG. 21. Such an architectural choice would increase performance by implementing a two radio relay for mobile to mobile paths which are relayed thorough node 3201, and would also increase the range and penetration of the radios on node 3201 which communicate with mobile nodes 3202 and 3203. Such radio antenna combinations could utilize 90° sector antennas, thus still providing 360° coverage to enable penetration of buildings in urban areas in order to reach mobile nodes which are carried by first responders. Some specific frequency choices are shown in FIG. 32 as exemplary, and are not specific requirements for this implementation. For example, A-channel and B-channel radios 3204 and 3205 respectively are shown as 800 MHz for communicating with mobile nodes 3202 and 3203. Operation at this frequency would provide extreme range and penetration for connecting to first responders who may be deep within building structures. These connections could utilize other frequencies including 4.9 GHz, a primary public safety band. C-channel and D-channel radios 3206 and 3207 respectively are shown as operating on 4.9 GHz and, as shown in FIG. 32, would relay information to other fixed nodes within the fixed mesh infrastructure. S-channel service radio 3208 is shown as 4.9 GHz and as such would be useful for providing a high-bandwidth connection to client devices within the vicinity of mesh node 3201. Synchronization of radios on common channels, adjacent channels, or even channels with some degree of separation will mitigate interference effects as shown in co-pending applications referenced earlier.

Connections between fixed interleaved mesh node 3101 and other fixed interleaved mesh nodes are accomplished by an additional set of radio antenna combinations 3108 through 3115, all typically operating on licensed public safety bands as are radios 3106 and 3107, as well as the two radios on each of nodes 3102 and 3103. Notice that the channel assignments on radio antenna combinations 3108 through 3115 may be done in any manner desired, and no longer have any effect on the ability of nodes 3102 and 3103 to make RF connections with node 3101 as they move from quadrant to quadrant. Thus, the channel assignments for radio antenna combinations 3108 through 3115 may be done as shown in FIG. 28, FIG. 26, or any other workable combination. If desired, the mesh for relay connections to other fixed nodes may not necessarily be interleaved and require for instance only antennas 3108, 3110, 3112, 3114, driven by either individual or common radios. Service antennas 3116 on node 3101 may represent individual radio-antenna combinations on different channels on four antennas or may be driven by a common radio as per FIGS. 16 or 17.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. A combined directional and mobile interleaved wireless mesh network, comprising:
a plurality of interleaved fixed directional mesh nodes, each directional node having at least a first relay radio assigned to communicate via a first channel and a second relay radio assigned to communicate via a second channel wherein said first radio and said second radio are each connected to one or more directional antennas wherein at least one directional antenna is aimed in a substantially orthogonal direction relative to at least one other directional antenna; and
a plurality of interleaved mobile mesh nodes, each mobile node having at least a third relay radio that communicates to the first relay radio of an adjacent directional node via the first channel and a fourth relay radio that communicates to the second relay radio of the adjacent directional node via the second channel wherein said third relay radio and said fourth relay radio are each connected to an omnidirectional antenna;
wherein said first common channel and said second common channel provide alternative paths for receiving packets to each node and for transmitting packets from each node such that an individual packet in a sequential stream of IP packets can utilize a different common channel than a packet which precedes said individual packet in the sequential stream.

2. The mesh network of claim 1 wherein the first radio and the second radio are each connected to four directional antennas by way of a radio frequency (RF) splitter and wherein each of said four directional antennas is aimed in one of four substantially orthogonal directions relative to one another and has a focused horizontal beam width angle of less than ninety degrees.

3. The mesh network of claim 2 wherein four independently controllable RF switches are positioned between said RF splitter and said four directional antennas such that transmission to at least one of said directions can be blocked in order to reduce interference on an adjacent node.

4. The mesh network of claim 1 wherein two adjacent packets in the sequential stream are propagated simultaneously via said first channel and said second channel.

5. The mesh network of claim 1 wherein a first packet is transmitted from a node via the first channel while a second packet is simultaneously being received to the node via the second channel.

6. The mesh network of claim 1 wherein each directional node has at least 8 radio-antenna combinations, each combination including a relay radio connected to a directional antenna, wherein at least two of said radio-antenna combinations are aimed in each of four substantially orthogonal directions relative to one another and wherein a first radio-antenna combination facing in each of said four directions communicates via the first channel and the second radio-antenna combination facing in each said four directions communicates via the second channel.

7. The mesh network of claim 1 wherein an individual packet from the sequential stream is received to a node via the first channel and transmitted from the node to an adjacent node via the second channel.

8. A combined directional and mobile interleaved wireless mesh network, comprising:
a plurality of fixed directional mesh nodes, each directional node having at least eight radio-antenna combinations, each combination including a radio connected to a directional antenna wherein at least two of said radio-antenna combinations cover each of four directional quadrants;
wherein a first radio-antenna combination covering one directional quadrant is assigned to communicate via a different channel than a second radio-antenna combination covering said one directional quadrant;
wherein one radio-antenna combination in each of said four directional quadrants operates on a common channel with one radio-antenna combination in an adjacent quadrant; and
wherein at least two of said radio-antenna combinations provide multiple parallel paths for receiving packets to said directional node from an adjacent node and for transmitting packets from said directional node to the adjacent node, such that an individual packet in a sequential stream of IP packets can utilize a different channel than a packet which precedes said individual packet in the sequential stream.

9. The mesh network of claim 8, further comprising:
a plurality of mobile mesh nodes, each mobile node having a first radio adapted to communicate with a radio-antenna combination of the directional node via a first channel and a second radio adapted to communicate with a different radio-antenna combination of the directional node via a second channel, wherein said first radio and said second radio are each connected to an omnidirectional antenna; and
wherein said first and second radios are also adapted to communicate with first and second radios on other mobile nodes respectively.

10. The mesh network of claim 9 wherein upon a mobile node moving from said one directional quadrant of the directional node into the adjacent directional quadrant, said first radio maintains a connection to the directional node via the first channel, said first channel being the common channel for the one quadrant and the adjacent quadrant of the directional node.

11. The mesh network of claim 10 wherein said second radio of the mobile node disengages from the directional node on said second channel and re-engages the directional node via a third channel while said first radio of the mobile node maintains said connection.

12. The mesh network of claim 11 whereby the mobile node maintains continuous uninterrupted communication with the directional node as the mobile node moves across a plurality of adjacent quadrants.

13. The mesh network of claim 8 wherein each of said four directional quadrants includes an area covered by two radio-antenna combinations aimed in the one of four substantially orthogonal directions.

14. The mesh network of claim 8 wherein each directional node communicates via four channels, each of said four channels covering two adjacent quadrants.

15. A combined directional and mobile interleaved wireless mesh network, comprising:
a plurality of fixed directional mesh nodes, each directional node having at least eight radio-antenna combinations, each combination including a radio connected to a directional antenna wherein at least two of said radio-antenna combinations are aimed in a substantially orthogonal direction relative to at least two others of said radio-antenna combinations;
wherein each of said radio-antenna combinations on a directional node is assigned to operate on a different channel from all other radio-antenna combinations on said directional node; and
wherein at least two of said radio-antenna combinations provide multiple parallel paths for receiving packets to said directional node from an adjacent node and for transmitting packets from said directional node to the adjacent node, such that an individual packet in a sequential stream of IP packets can utilize a different channel than a packet which precedes said individual packet in the sequential stream.

16. The mesh network of claim 15, further comprising:
a plurality of mobile mesh nodes, each mobile node having a first radio adapted to communicate with a first radio-antenna combination of the directional node via a first channel and a second radio adapted to communicate with a second radio-antenna combination of the directional node via a second channel, wherein said first radio and said second radio are each connected to an omnidirectional antenna; and
wherein said first and second radios are also adapted to communicate with first and second radios on other mobile mesh nodes respectively.

17. The mesh network of claim 16 wherein upon a mobile node roaming around the directional node, said first radio disengages communication with said first radio-antenna combination of the directional node and re-engages a third radio-antenna combination of the directional node via a third channel, said third radio-antenna combination facing in a direction substantially orthogonal to the first radio-antenna combination.

18. The mesh network of claim 17 wherein the second radio of the mobile node maintains a connection to the second-radio antenna combination of the directional node while said first radio of the mobile node disengages and re-engages communication with the directional node.

19. The mesh network of claim 18 wherein the second radio of the mobile node transmits instructions to any connected ad hoc mobile nodes via the second radio, said instructions informing the connected ad hoc mobile nodes to switch communication on said first radio from the first channel to the third channel.

20. The mesh network of claim 15 wherein the plurality of fixed directional nodes comprise a substantially rectangular directional grid wherein directional nodes that are positioned diagonally on the grid have identical channel assignments.

21. A combined directional and mobile interleaved wireless mesh network, comprising:
a plurality of mobile mesh nodes, each mobile node including a first and second relay radios assigned to operate on different channels, each relay radio connected to an omnidirectional antenna and suitable for communicating with directional nodes and with other mobile nodes; and
a plurality of fixed directional mesh nodes, each directional node including a third relay radio dedicated to communicate with other fixed directional nodes, said third relay radio connected to at least one of a first group of at least four directional antennas, each directional antenna being aimed in a substantially orthogonal direction relative to at least one other directional antenna; and
wherein each fixed directional node further includes at least two mobile-assigned relay radios dedicated to communicate with mobile nodes, wherein said two mobile-assigned relay radios provide alternative paths for receiving and transmitting packets between said fixed directional node and said mobile nodes such that an individual packet in a sequential stream of IP packets can utilize a different channel than a packet which precedes said individual packet in the sequential stream.

22. The combined directional and mobile interleaved wireless mesh network of claim 21 wherein each fixed directional node further includes a fourth relay radio assigned to communicate with other fixed directional nodes, said fourth relay radio connected to at least one of a second group of at least four directional antennas and assigned to operate on a different channel than said third relay radio; and
wherein said third relay radio and said fourth relay radio provide alternative paths for receiving and transmitting packets between said directional node and other fixed directional nodes such that an individual packet in a sequential stream of IP packets can utilize a different channel than a packet which precedes said individual packet in the sequential stream.

23. The combined directional and mobile interleaved wireless mesh network of claim 21 wherein each of said two mobile-assigned relay radios of each directional node is connected to at least four directional antennas by way of an RF splitter.
